(19) United States
(12) Patent Application Publication
(10) Pub. No.: US 2023/0185164 A1
(43) Pub. Date: Jun. 15, 2023

(54) CAMERA MODULE

(71) Applicant: Samsung Electro-Mechanics Co., Ltd., Suwon-si (KR)

(72) Inventors: Kyung Hun LEE, Suwon-si (KR); Jong Ho LEE, Suwon-si (KR)

(73) Assignee: Samsung Electro-Mechanics Co., Ltd., Suwon-si (KR)

(21) Appl. No.: 18/079,975

(22) Filed: Dec. 13, 2022

(30) Foreign Application Priority Data
Dec. 13, 2021 (KR) 10-2021-0177926
Aug. 11, 2022 (KR) 10-2022-0100767

(51) Int. Cl. G03B 13/36; G02B 7/02; H01F 7/08; H04N 23/51; H04N 23/54

(52) U.S. Cl. CPC G03B 13/36; G02B 7/021; H01F 7/081; H04N 23/51; H04N 23/54; H04N 23/687

(57) ABSTRACT

A camera module includes a lens module including at least one lens; a housing in which the lens module is disposed; a magnet disposed on the lens module; a coil facing the magnet; a first yoke member fixed to the housing; and first and second ball units disposed between the lens module and the housing, spaced apart from each other in a first direction perpendicular to an optical axis, and each including a plurality of balls disposed in a direction parallel to the optical axis, wherein the lens module includes a first extension protruding in the direction parallel to the optical axis, the housing includes a second extension protruding in the direction parallel to the optical axis and accommodating at least a portion of the first extension, and at least one ball among the balls included in the first and second ball units is disposed between the first and second extensions.

### CROSS-REFERENCE TO RELATED APPLICATIONS

This application claims the benefit under 35 USC 119(a) of Korean Patent Application Nos. 10-2021-0177926 filed on Dec. 13, 2021, and 10-2022-0100767 filed on Aug. 11, 2022, in the Korean Intellectual Property Office, the entire disclosures of which are incorporated herein by reference for all purposes.

### BACKGROUND

### 1. Field

The present disclosure relates to a camera module.

### 2. Description of Related Art

A camera module has become a standard feature in a mobile communications terminal such as a tablet personal computer (PC) or a laptop computer, as well as a smartphone.

The camera module typically includes an actuator having an autofocusing function to generate a high-resolution image.

For example, the actuator having the autofocusing function may include a magnet and a coil for generating a driving force to move a lens module in an optical axis direction, and may further include a plurality of ball units supporting the lens module to be movable in the optical axis direction.

The lens module may need to be moved in a direction parallel to the optical axis direction (i.e., without being tilted relative to the optical axis direction) to improve an autofocusing performance of the camera module.

However, there is a risk that the lens module may be tilted relative to the optical axis direction while being moved in the optical axis direction when the movement of the lens module in the optical axis direction is supported by the plurality of ball units.

It may be desirable for the camera module to have a smaller size in addition to an improved autofocusing performance. The camera module may thus have a smaller size (e.g., a smaller height in the optical axis direction), which may cause the lens module to be tilted relative to the optical axis direction when the lens module is moved in the optical axis direction, thereby adversely affecting the autofocusing performance of the lens module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module including at least one lens; a housing in which the lens module is disposed; a magnet disposed on the lens module; a coil facing the magnet; a first yoke member fixed to the housing; and a first ball unit and a second ball unit disposed between the lens module and the housing, spaced apart from each other in a first direction perpendicular to an optical axis of the lens module, and each including a plurality of balls disposed in a direction parallel to the optical axis, wherein the lens module includes a first extension protruding in the direction parallel to the optical axis, the housing includes a second extension protruding in the direction parallel to the optical axis and accommodating at least a portion of the first extension, and at least one ball among the plurality of balls included in the first ball unit or the plurality of balls included in the second ball unit is disposed between the first extension and the second extension.

A number of the plurality of balls included in the first ball unit may be different from a number of the plurality of balls included in the second ball unit.

A distance between two balls respectively positioned at outermost sides in the direction parallel to the optical axis among the plurality of balls included in the first ball unit may be greater than a distance between two balls respectively positioned at outermost sides in the direction parallel to the optical axis among the plurality of balls included in the second ball unit.

The at least one ball disposed between the first extension and the second extension may be at least one ball among the plurality of balls included in the first ball unit.

A center of gravity of the lens module may be positioned closer to the first ball unit than to the second ball unit.

At least a portion of at least one ball among the plurality of balls included in the first ball unit may be positioned below the magnet in the direction parallel to the optical axis.

Two balls respectively positioned at outermost sides in the direction parallel to the optical axis among the plurality of balls included in the first ball unit may be in two-point contact with the lens module and the housing, and two balls respectively positioned at outermost sides in the direction parallel to the optical axis among the plurality of balls included in the second ball unit may be in two-point contact with the lens module and one-point contact with the housing, or may be in one-point contact with the lens module and two-point contact with the housing.

An action center point of an attractive force acting between the magnet and the first yoke member may be positioned closer to the first ball unit than to the second ball unit.

A center of the magnet may be positioned closer to the first ball unit than to the second ball unit.

The camera module may further include a second yoke member fixed to the housing and facing the magnet, wherein the second yoke member may be positioned closer to a ball unit including more balls among the first ball unit and the second ball unit.

The camera module may further include a substrate fixed to the housing, wherein the coil and the second yoke member may be disposed on one surface of the substrate, and the first yoke member may be disposed on another surface of the substrate.

The camera module may further include a substrate fixed to the housing and including a through-hole passing through the substrate, wherein the coil may be disposed on one surface of the substrate, and the first yoke member may disposed on another surface of the substrate, and the second yoke member may be mounted on the first yoke member facing the magnet through the through-hole hole.

The camera module may further include a buffer member disposed on either one or both of a surface of the first extension and a surface of the second extension facing each other in the direction parallel to the optical axis.

The magnet may be disposed closer to a lower surface of the lens module than to an upper surface of the lens module.

The camera module may further include a printed circuit board coupled to the housing; and an image sensor mounted on the printed circuit board and including an imaging surface, wherein the printed circuit board may include a clearance region in which the second extension is disposed, and the clearance region may be a recess formed in a surface of the printed circuit board facing the housing in the direction parallel to the optical axis, or a through-hole passing through the substrate in the direction parallel to the optical axis.

In another general aspect, a camera module includes a lens module including at least one lens; a housing in which the lens module is disposed; a magnet disposed on the lens module; a coil facing the magnet; a first yoke member fixed to the housing; a first ball unit and a second ball unit disposed between the lens module and the housing, spaced apart from each other in a first direction perpendicular to an optical axis of the lens module, and each including a plurality of balls disposed in a direction parallel to the optical axis; a printed circuit board coupled to the housing; and an image sensor mounted on the printed circuit board and including an imaging surface, wherein a number of the plurality of balls included in the first ball unit is greater than a number of the plurality of balls included in the second ball unit, and at least a portion of one ball among two balls respectively positioned at outermost sides in the direction parallel to the optical axis among the plurality of balls included in the first ball unit is positioned below the imaging surface.

Each ball among the two balls respectively positioned at the outermost sides in the direction parallel to the optical axis among the plurality of balls included in the first ball unit may have a diameter greater than a diameter of at least one ball among the plurality of balls included in the first ball unit positioned between the two balls.

The lens module may include a first extension protruding in the direction parallel to the optical axis, the housing may include a second extension protruding in the direction parallel to the optical axis and accommodating at least a portion of the first extension; at least one ball among the plurality of balls included in the first ball unit may be disposed between the first extension and the second extension, and at least a portion of the at least one ball disposed between the first extension and the second extension may be positioned below the imaging surface.

The printed circuit board may include a clearance region in which the second extension is disposed, and the clearance region may be a recess formed in a surface of the printed circuit board facing the housing in the direction parallel to the optical axis, or a through-hole passing through the printed-circuit board in the direction parallel to the optical axis.

An action center point of an attractive force acting between the magnet and the first yoke member may be positioned closer to the first ball unit than to the second ball unit.

A center of gravity of the lens module may be positioned closer to the first ball unit than to the second ball unit.

In another general aspect, a camera module includes a lens module including at least one lens and a first extension protruding in a direction parallel to an optical axis of the lens module; a housing including a second extension protruding in the direction parallel to the optical axis and accommodating at least a portion of the first extension; a first ball unit and a second ball unit disposed between the lens module and the housing, spaced apart from each other in a first direction perpendicular to the optical axis, and each including a plurality of balls disposed in the direction parallel to the optical axis; a fixed frame coupled to the housing and including a first accommodation part in which the second extension is disposed; a moving frame disposed in the fixed frame and configured to be movable on a plane perpendicular to the optical axis; a third ball unit disposed between the fixed frame and the moving frame; a sensor substrate including: a moving part coupled to the moving frame; and a fixed part coupled to the fixed frame; and an image sensor mounted on the moving part, wherein at least one ball among the plurality of balls included in the first ball unit or the plurality of balls included in the second ball unit is disposed between the first extension and the second extension.

The camera module may further include a first driving unit configured to move the lens module in an optical axis direction of the lens module, wherein the first driving unit may include a first magnet disposed on the lens module; a first coil fixed to the housing and facing the first magnet; and a first yoke member fixed to the housing, a number of the plurality of balls included in the first ball unit may be greater than a number of the plurality of balls included in the second ball unit, and each ball among two balls respectively positioned at outermost sides in the direction parallel to the optical axis among the plurality of balls included in the first ball unit may have a diameter greater than a diameter of at least one ball among the plurality of balls included in the first ball unit positioned between the two balls.

An action center point of an attractive force acting between the first magnet and the first yoke member may be positioned closer to the first ball unit than to the second ball unit.

The camera module may further include a second driving unit configured to drive the lens module in the first direction perpendicular to the optical axis; and a third driving unit configured to drive the lens module in a second direction perpendicular to both the optical axis and the first direction, wherein the second driving unit may include a second magnet disposed on the moving frame and a second coil fixed to the fixed frame, or a second magnet disposed on the fixed frame and a second coil fixed to the moving frame, the third driving unit may include a third magnet disposed on the moving frame and a third coil fixed to the fixed frame, or a third magnet disposed on the fixed frame and a third coil fixed to the moving frame, the second magnet and the second coil may face each other in the direction parallel to the optical axis, and the third magnet and the third coil may face each other in the direction parallel to the optical axis.

The sensor substrate may further include a connection part connecting the moving part and the fixed part with each other, and the connection part may include a plurality of slits extending along a perimeter of the moving part and passing through the connection part in the optical axis direction.

In another general aspect, a camera module includes a lens module including at least one lens; a carrier in which the lens module is disposed; a housing in which the carrier having the lens module disposed therein is disposed; a first substrate mounted on the housing; an autofocusing unit including a first magnet disposed on the carrier and a first coil disposed on the first substrate; an optical image stabilization unit including a second magnet and a third magnet disposed on the lens module, and a second coil and a third coil disposed on the first substrate; a first ball unit and a second ball unit disposed between the carrier and the housing, spaced apart from each other in a first direction perpendicular to an optical axis of the lens module, and each including a plurality of balls disposed in a direction parallel to the optical axis; and a ball unit supporting the lens module so that the lens module is movable relative to the carrier in the direction perpendicular to the optical axis, wherein a number of the plurality of balls included in the first ball unit is greater than a number of the plurality of balls included in the second ball unit, the carrier includes a first extension protruding in the direction parallel to the optical axis, the housing includes a second extension protruding in the direction parallel to the optical axis and accommodating at least a portion of the first extension; and at least one ball among the plurality of balls included in the first ball unit is disposed between the first extension and the second extension.

Each ball among two balls respectively positioned at outermost sides in the direction parallel to the optical axis among the plurality of balls included in the first ball unit may have a diameter greater than a diameter of at least one ball among the plurality of balls included in the first ball unit positioned between the two balls, and at least one ball among the two balls respectively positioned at outermost sides in the direction parallel to the optical axis may be disposed between the first extension and the second extension.

The camera module of claim may further include a first yoke member mounted on the first substrate, wherein an action center point of an attractive force acting between the first magnet and the first yoke member may be positioned closer to the first ball unit than to the second ball unit.

The lens module and the carrier may be configured to be movable together in an optical axis direction of the lens module, and the lens module may be configured to be movable relative to the carrier in the first direction perpendicular to the optical axis and a second direction perpendicular to the optical axis and intersecting the first direction.

The camera module may further include a printed circuit board coupled to the housing; and an image sensor mounted on the printed circuit board and including an imaging surface, wherein the printed circuit board may include a clearance region in which the second extension is disposed, and the clearance region may be a recess formed in a surface of the printed circuit board facing the substrate in the direction parallel to the optical axis, or a through-hole passing through the substrate in the direction parallel to the optical axis.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of the camera module of FIG. 1.

FIG. 3 is a side view of a carrier of the camera module of FIG. 1.

FIG. 4 is a perspective view of a housing of the camera module of FIG. 1.

FIG. 5 is a cross-sectional view taken along the line V-V′ of FIG. 1.

FIG. 6 is a modified example of a position of a magnet mounted on the carrier of the camera module of FIG. 1.

FIG. 7 is a view for explaining a second yoke member of the camera module of FIG. 1.

FIGS. 8 and 9 are modified examples of FIG. 7.

FIG. 10 is a perspective view of a camera module according to another example embodiment of the present disclosure.

FIG. 11 is a view illustrating a first actuator and a second actuator of the camera module of FIG. 10 being separated from each other.

FIG. 12 is a schematic exploded perspective view of the camera module of FIG. 10.

FIG. 13 is an exploded perspective view of the second actuator of the camera module of FIG. 10.

FIG. 14 is an exploded perspective view of a second driving unit and a third driving unit of the second actuator of the camera module of FIG. 10.

FIG. 15 is a perspective view of the second actuator of the camera module of FIG. 10.

FIG. 16A is a cross-sectional view taken along the line XVIA-XVIA′ of FIG. 15.

FIG. 16B is an enlarged view of a portion A of FIG. 16A.

FIG. 17A is a cross-sectional view taken along the line XVIIA-XVIIA′ of FIG. 15.

FIG. 17B is an enlarged view of a portion B of FIG. 17A.

FIG. 18 is an example of a moving frame of the second actuator of the camera module of FIG. 10.

FIG. 19 is a plan view of a sensor substrate of the second actuator of the camera module of FIG. 10.

FIG. 20 is a modified example of FIG. 18.

FIG. 21 is a perspective view of the moving frame and the sensor substrate of the second actuator of the camera module of FIG. 10.

FIG. 22 is a plan view illustrating the moving frame and the sensor substrate of the second actuator of the camera module of FIG. 10 being coupled to each other.

FIG. 23 is a perspective view of the first actuator of the camera module of FIG. 10.

FIG. 24 is an exploded perspective view of the first actuator of the camera module of FIG. 10.

FIG. 25 is a schematic exploded perspective view of a camera module according to another example embodiment of the present disclosure.

FIG. 26 is a front view of a carrier of the camera module of FIG. 25.

FIG. 27 is a front view of a housing of the camera module of FIG. 25.

FIG. 28 is a view illustrating an arrangement of second and third magnets, second and third coils, and second and third position sensors of the camera module of FIG. 25.

FIG. 29 is a modified example of FIG. 28.

FIG. 30 is an exploded perspective view of a modified example of the camera module of FIG. 25.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

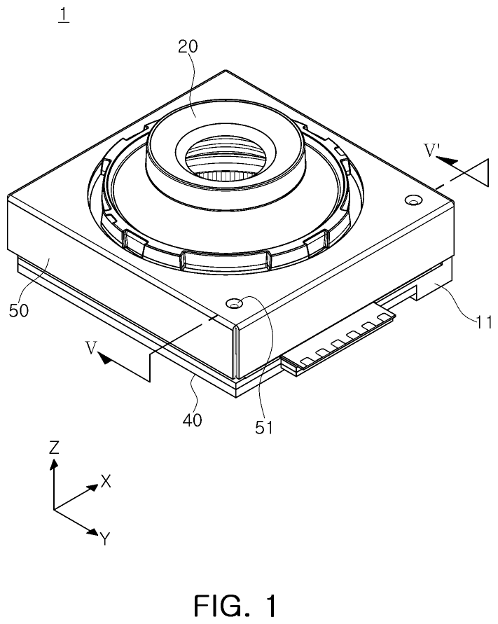

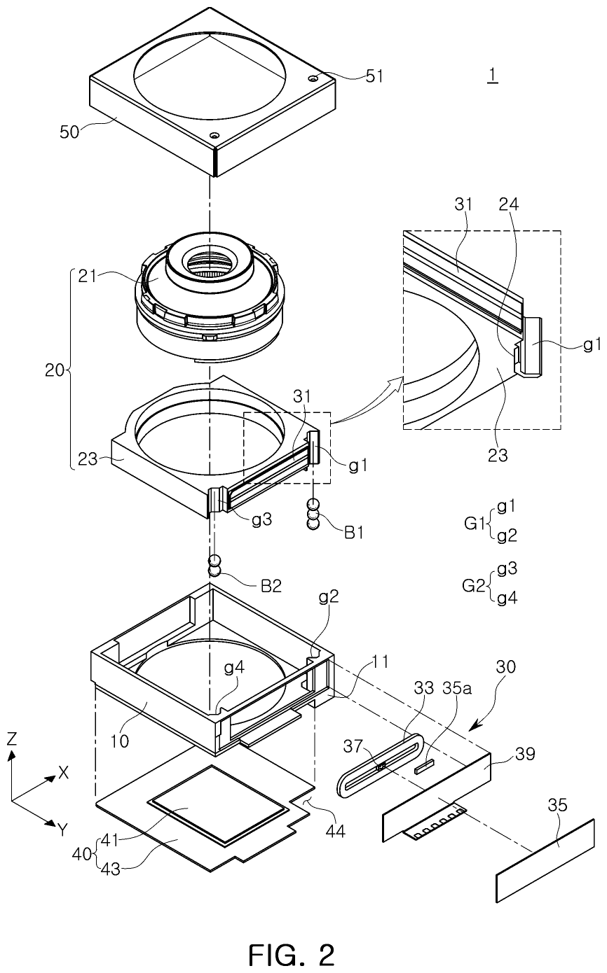

FIG. 1 is a perspective view of a camera module according to an example embodiment of the present disclosure, and FIG. 2 is a schematic exploded perspective view of the camera module of FIG. 1.

The camera module according to an example embodiment of the present disclosure may be mounted in a portable electronic device. The portable electronic device may be a mobile electronic device such as a mobile communications terminal, a smartphone, or a tablet personal computer (PC).

Referring to FIGS. 1 and 2, a camera module 1 may include a lens module 20, a housing 10, and a driving unit 30, and may further include a case 50.

The lens module 20 may include at least one lens and a lens barrel 21. The least one lens may be disposed in the lens barrel 21. The lens module 20 may include a plurality of lenses, and in this case, the plurality of lenses may be mounted in the lens barrel 21 along an optical axis (Z-axis).

The lens module 20 may further include a carrier 23 coupled to the lens barrel 21.

In an example embodiment of the present disclosure, the lens module 20 may be a moving member which may be moved in an optical axis (Z-axis) direction when performing autofocusing (AF). The lens module 20 may be moved in the optical axis (Z-axis) direction to perform autofocusing (AF).

The carrier 23 may include an opening penetrating through the carrier 23 in the optical axis (Z-axis) direction, and the lens barrel 21 may be inserted into the opening and fixed to the carrier 23. The lens barrel 21 and the carrier 23 may thus be moved together in the optical axis (Z-axis) direction.

The housing 10 may have an internal space, and may have a shape of a rectangular box having an open top and an open bottom. The lens module 20 may be disposed in the internal space of the housing 10.

The case 50 may be coupled to the housing 10 to protect components in the camera module 1.

The case 50 may include a protrusion 51 protruding toward a first ball unit B1 and a second ball unit B2, which are described below. The protrusion 51 may serve as a stopper and a buffer member for restricting the movement range of each of the first ball unit B1 and the second ball unit B2.

The driving unit 30 may generate a driving force in the optical axis (Z-axis) direction to move the carrier 23 in the optical axis (Z-axis) direction.

The driving unit 30 may include a magnet 31 and a coil 33. The magnet 31 and the coil 33 may be disposed to face each other in a second axis (Y-axis) direction perpendicular to the optical axis (Z-axis).

The magnet 31 may be disposed on the carrier 23. For example, the magnet 31 may be disposed on one side surface of the carrier 23.

A back yoke (not shown) may be disposed between the carrier 23 and the magnet 31. The back yoke may improve the driving force by preventing magnetic flux leakage of the magnet 31.

The magnet 31 may be magnetized so that one surface (e.g., a surface facing the coil 33) thereof has both an N pole and an S pole. For example, the N pole, a neutral region, and the S pole may be sequentially arranged in the optical axis (Z-axis) direction on the one surface of the magnet 31 facing the coil 33.

The other surface (e.g., a surface opposite to the one surface) of the magnet 31 may be magnetized to have both an S pole and an N pole. For example, the S pole, the neutral region, and the N pole may be sequentially arranged in the optical axis (Z-axis) direction on the other surface of the magnet 31 so that the S pole on the other surface opposes the N pole on the one surface, and the N pole on the other surface opposes the S pole on the one surface.

The coil 33 may be disposed to face the magnet 31. For example, the coil 33 may be disposed to face the magnet 31 in the second axis (Y-axis) direction perpendicular to the optical axis (Z-axis).

The coil 33 may be disposed on a substrate 39, and the substrate 39 may be mounted on the housing 10 so that the magnet 31 and the coil 33 face each other in the second axis (Y-axis) direction perpendicular to the optical axis (Z-axis). The coil 33 may thus be fixed to the housing 10.

The magnet 31 may be a moving member mounted on the carrier 23 to be moved together with the carrier 23 in the optical axis (Z-axis) direction, and the coil 33 may be a fixed member fixed to the substrate 39.

The carrier 23 may be moved in the optical axis (Z-axis) direction by an electromagnetic force generated between the magnet 31 and the coil 33 when power is applied to the coil 33.

The lens barrel 21 may be coupled to the carrier 23, and the lens barrel 21 may thus also be moved in the optical axis (Z-axis) direction as the carrier 23 is moved.

The first ball unit B1 and the second ball unit B2 may be disposed between the lens module 20 (e.g., the carrier 23) and the housing 10. The first ball unit B1 and the second ball unit B2 may be spaced apart from each other in a first axis (X-axis) direction perpendicular to the optical axis (Z-axis).

The first ball unit B1 and the second ball unit B2 may each include a plurality of balls disposed in a direction parallel to the optical axis (Z-axis). The plurality of balls may roll in the optical axis (Z-axis) direction when the carrier 23 is moved in the optical axis (Z-axis) direction.

A first yoke member 35 may be disposed on the housing 10. The first yoke member 35 may be disposed to face the magnet 31. For example, the coil 33 may be disposed on one surface of the substrate 39, and the first yoke member 35 may be disposed on the other surface (e.g., a surface opposite to the one surface) of the substrate 39. The first yoke member 35 may thus be fixed to the housing 10.

The magnet 31 and the first yoke member 35 may generate an attractive force between each other. For example, the attractive force may act between the magnet 31 and the first yoke member 35 in the second axis (Y-axis) direction perpendicular to the optical axis (Z-axis).

The first ball unit B1 and the second ball unit B2 may be kept in contact with the carrier 23 and the housing 10 by the attractive force acting between the magnet 31 and the first yoke member 35.

Guide groove parts may be formed in surfaces of the carrier 23 and the housing 10 facing each other. For example, a first guide groove part G1 may be formed in each of the surfaces of the carrier 23 and the housing 10 facing each other on one side of the carrier 23 and the housing 10 in the first axis (X-axis) direction perpendicular to the optical axis (Z-axis), and a second guide groove part G2 may be formed in each of the surfaces of the carrier 23 and the housing 10 facing each other on the other side of the carrier 23 and the housing 10 in the first axis (X-axis) direction perpendicular to the optical axis (Z-axis). Thus, the first guide groove part G1 and the second guide groove part G2 may be spaced apart from each other in the first axis (X-axis) direction perpendicular to the optical axis (Z-axis).

The first guide groove part G1 and the second guide groove part G2 may extend in the direction parallel to the optical axis (Z-axis). The first ball unit B1 may be disposed in the first guide groove part G1, and the second ball unit B2 may be disposed in the second guide groove part G2.

The first guide groove part G1 may include a first guide groove g1 formed in the carrier 23 and a second guide groove g2 formed in the housing 10, and the second guide groove part G2 may include a third guide groove g3 formed in the carrier 23 and a fourth guide groove g4 formed in the housing 10. Each guide groove may have a length extending in the direction parallel to the optical axis (Z-axis).

The first guide groove g1 and the second guide groove g2 may be disposed to face each other in the second axis (Y-axis) direction perpendicular to the optical axis (Z-axis) direction, and the first ball unit B1 may be disposed in a space between the first guide groove g1 and the second guide groove g2.

Each of the balls positioned outermost in the direction parallel to the optical axis (Z-axis) among the plurality of balls included in the first ball unit B1 may be in two-point contact with the first guide groove g1 and the second guide groove g2.

That is, each of the balls positioned outermost in the direction parallel to the optical axis (Z-axis) among the plurality of balls included in the first ball unit B1 may be in two-point contact with the first guide groove g1 and in two-point contact with the second guide groove g2.

The first ball unit B1, the first guide groove g1, and the second guide groove g2 may collectively function as a main guide for guiding the movement of the lens module 20 in the optical axis (Z-axis) direction.

In addition, the third guide groove g3 and the fourth guide groove g4 may be disposed to face each other in the second axis (Y-axis) direction perpendicular to the optical axis (Z-axis) direction, and the second ball unit B2 may be disposed in a space between the third guide groove g3 and the fourth guide groove g4.

Each of the balls positioned outermost in the direction parallel to the optical axis (Z-axis) among the plurality of balls included in the second ball unit B2 may be in two-point contact with either one of the third guide groove g3 and the fourth guide groove g4, and in one-point contact with the other one thereof.

For example, each of the balls positioned outermost in the direction parallel to the optical axis (Z-axis) among the plurality of balls included in the second ball unit B2 may be in one-point contact with the third guide groove g3, and in two-point contact with the fourth guide groove g4 (and vice versa). The second ball unit B2, the third guide groove g3, and the fourth guide groove g4 may collectively function as an auxiliary guide for guiding the movement of the lens module 20 in the optical axis (Z-axis) direction.

The first ball unit B1 and the second ball unit B2 may be spaced apart from each other in the first axis (X-axis) direction perpendicular to the optical axis (Z-axis), and may each include a plurality of balls. A number of the balls included in the first ball unit B1 and a number of the balls included in the second ball unit B2 may be different from each other (see FIG. 2).

For example, the first ball unit B1 may include three or more balls arranged in the direction parallel to the optical axis (Z-axis), and the second ball unit B2 may include a smaller number of balls than the number of balls included in the first ball unit B1.

The number of balls included in each ball unit may be changed as long as the number of balls included in the first ball unit B1 is different from the number of balls included in the second ball unit B2. Hereinafter, for convenience of description, the description describes an example in which the first ball unit B1 includes three balls and the second ball unit B2 includes two balls.

The two balls positioned outermost in the direction parallel to the optical axis (Z-axis) among the three balls included in the first ball unit B1 may have a same diameter as each other, and the one ball disposed between these two balls may have a smaller diameter than the diameter of these two balls.

For example, each of the two balls positioned outermost in the direction parallel to the optical axis (Z-axis) among the three balls included in the first ball unit B1 may have a first diameter, and the one ball disposed between these two balls may have a second diameter, with the first diameter being greater than the second diameter.

The two balls included in the second ball unit B2 may have a same diameter as each other. For example, each of the two balls included in the second ball unit B2 may have a third diameter.

The first diameter and the third diameter may be the same as each other. The expression “same diameter” may indicate the same diameter including a manufacturing error as well as the physically same diameter.

A distance between the centers of the two balls positioned outermost in the direction parallel to the optical axis (Z-axis) among the three balls included in the first ball unit B1 may be different from a distance between the centers of the two balls positioned outermost in the direction parallel to the optical axis (Z-axis) among the two balls included in the second ball unit B2.

For example, a distance between the centers of two balls each having the first diameter may be greater than a distance between the centers of two balls each having the third diameter.

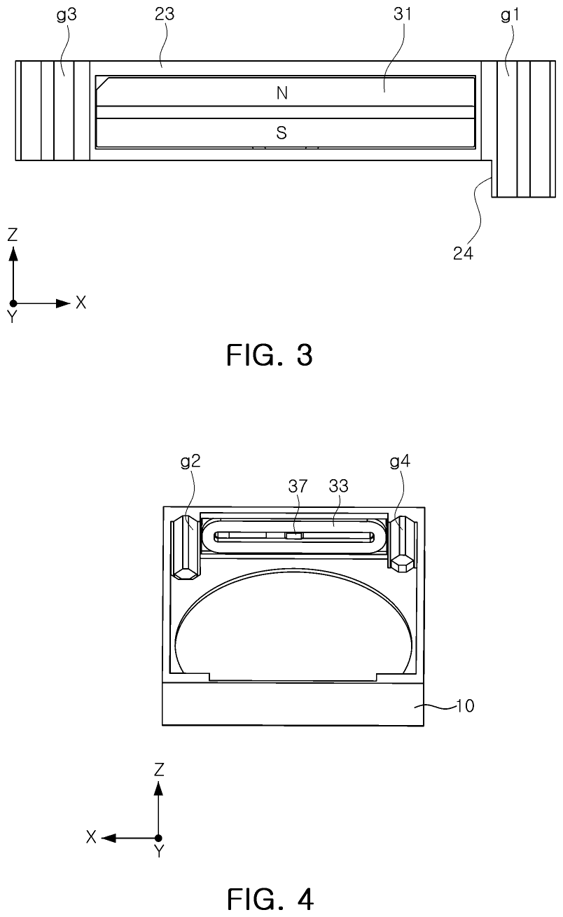

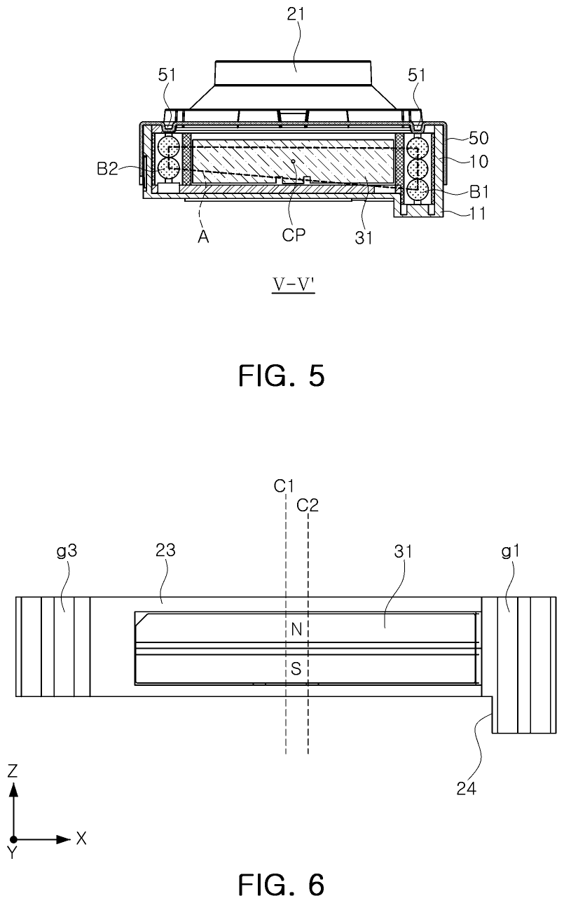

FIG. 3 is a side view of a carrier of the camera module of FIG. 1; FIG. 4 is a perspective view of a housing of the camera module of FIG. 1; and FIG. 5 is a cross-sectional view taken along the line V-V′ of FIG. 1.

An action center point CP of the attractive force acting between the magnet 31 and the first yoke member 35 needs to be positioned within a support region A defined by connecting together contact points where the first ball unit B1 and the second ball unit B2 contact the carrier 23 (or the housing 10) in order for the carrier 23 to be moved parallel to the optical axis (Z-axis) direction (that is, to be prevent the carrier 23 from being tilted) when moved in the optical axis (Z-axis) direction.

If the action center point CP of the attractive force is outside the support region A, the carrier 23 may have a shifted position during its movement, which may cause a risk that the carrier 23 is tilted. Therefore, it is necessary to make the support region A as wide as possible in the direction parallel to the optical axis Z-axis).

In an example embodiment of the present disclosure, the size (e.g., diameter) of some of the plurality of balls included in the first ball unit B1 may be intentionally larger than the size (e.g., diameter) of the other balls included in the first ball unit B1. In this case, the larger balls among the plurality of balls included in the first ball unit B1 may be intentionally brought into contact with the carrier 23 (or the housing 10).

Referring to FIG. 5, the diameters of two balls among the three balls of the first ball unit B1 may be larger than the diameter of the other ball, and these two balls of the first ball unit B1 may thus each be in contact with the carrier 23 or the housing 10. In addition, the two balls of the second ball unit B2 may have the same diameter as each other, and the two balls of the second ball unit B2 may thus each be in contact with the carrier 23 and the housing 10.

Accordingly, as shown in FIG. 5, the first ball unit B1 and the second ball unit B2 may be in four-point contact with the carrier 23 (or the housing 10) when viewed in the second axis (Y-axis) direction. Therefore, the support region A defined by connecting together the four contact points where the first ball unit B1 and the second ball unit B2 contact the carrier 23 (or the housing 10) may have a quadrilateral shape (e.g., a trapezoidal shape) as shown in FIG. 5.

Therefore, the support region A may be made wider in the direction parallel to the optical axis Z-axis), and the action center point CP of the attractive force acting between the magnet 31 and the first yoke member 35 may thus be stably positioned within the support region A. It is thus possible to ensure a driving stability of the camera module during the autofocusing.

However, the two balls of the second ball unit B2 may not physically have exactly the same diameter as each other due to a manufacturing error or other reason even when the two balls of the second ball unit B2 are intended to be manufactured to have the same diameter. In this case, only one of the two balls of the second ball unit B2 may be in contact with the carrier 23 (or the housing 10).

Accordingly, the first ball unit B1 and the second ball unit B2 may be in three-point contact with the carrier 23 (or the housing 10) when viewed in the second axis (Y-axis) direction Therefore, the support region A defined by connecting together the three contact points where the first ball unit B1 and the second ball unit B2 contact the carrier 23 (or the housing 10) may have a triangular shape.

However, even the support region A having the triangular shape may still be made wide in the direction parallel to the optical axis Z-axis) by the two balls positioned outermost in the direction parallel to the optical axis Z-axis) among the three balls of the first ball unit B1, thus securing the driving stability of the camera module during the autofocusing.

It may also be important for the camera module 1 to have a smaller height (or to be made slim) in the optical axis (Z-axis) direction apart from securing the driving stability during the autofocusing. The support region A may also have a smaller height in the optical axis (Z-axis) direction when the camera module 1 is simply made to have a smaller height in the optical axis (Z-axis) direction.

Accordingly, there is a risk that a problem may occur in the driving stability of the camera module during the autofocusing when the camera module 1 is simply made to have a smaller height in the optical axis (Z-axis) direction.

Accordingly, the camera module 1 according to an example embodiment of the present disclosure may have lengths of the first guide groove part G1 and the second guide groove part G2 in the optical axis (Z-axis) direction made different from each other. For example, the length of the first guide groove part G1 in the optical axis (Z-axis) direction may be greater than the length of the second guide groove part G2 in the optical axis (Z-axis) direction.

Referring to FIG. 3, the first guide groove g1 may extend from a lower surface of the carrier 23 into a portion protruding in the optical axis (Z-axis) direction. For example, a first extension 24 protruding in the direction parallel to the optical axis (Z-axis) may be disposed on the lower surface of the carrier 23, and the first guide groove g1 may extend into the first extension 24. A length of the first guide groove g1 may be greater than a length of the third guide groove g3 by a length of the first extension 24.

The first extension 24 may protrude from the lower surface of the carrier 23, and a center of gravity of the lens module 20 may thus be positioned closer to the first guide groove g1 than to the third guide groove g3.

The first ball unit B1 may be disposed in the first guide groove g1 and the second ball unit B2 may be disposed in the third guide groove g3, and the center of gravity of the lens module 20 may thus be positioned closer to the first ball unit B1 than to the second ball unit B2.

In addition, referring to FIGS. 4 and 5, the second guide groove g2 may protrude from a lower surface of the housing 10 in the direction parallel to the optical axis (Z-axis). For example, a second extension 11 may protrude downward from the lower surface of the housing 10 in the direction parallel to the optical axis (Z-axis). A length of the second guide groove g2 may be greater than a length of the fourth guide groove g4 by a length of the second extension 11.

The second extension 11 may protrude from the lower surface of the housing 10, and the center of gravity of the housing 10 may thus be positioned closer to the second guide groove g2 than to the fourth guide groove g4.

The first ball unit B1 may be disposed in the second guide groove g2 and the second ball unit B2 may be disposed in the fourth guide groove g4, and the center of gravity of the housing 10 may thus be positioned closer to the first ball unit B1 than to the second ball unit B2.

The second extension 11 may have an accommodation space for accommodating the first extension 24, and at least a portion of the first extension 24 may be accommodated in the second extension 11.

The first extension 24 and the second extension 11 may have surfaces facing each other in the direction perpendicular to the optical axis (Z-axis), and at least one of the plurality of balls included in the first ball unit B1 may be disposed between the first extension 24 and the second extension 11. For example, a ball positioned at the lowermost side in the direction parallel to the optical axis (Z-axis) among the three balls of the first ball unit B1 may be disposed between the first extension 24 and the second extension 11.

At least one of the plurality of balls included in the first ball unit B1 may be positioned below the magnet 31 in the direction parallel to the optical axis (Z-axis). For example, the center of the ball disposed between the first extension 24 and the second extension 11 may be positioned below a lower surface of the magnet 31 in the direction parallel to the optical axis (Z-axis) as shown in FIG. 5.

The magnet 31 may be positioned closer to a lower surface of the lens module 20 (or that of the carrier 23) than to an upper surface of the lens module 20 (or that of the carrier 23).

The first guide groove part G1, which is part of the main guide, may have a length greater than a length of the second guide groove part G2, which is part of the auxiliary guide, and the camera module 1 may thus have a smaller size in the optical axis (Z-axis) direction while the support region A has a greater height in the optical axis (Z-axis) direction.

Through this configuration, the camera module 1 may achieve its slimness by having a smaller height in the optical axis (Z-axis) direction while securing a driving stability during the autofocusing.

A buffer member (not shown) may be disposed on either one both of surfaces of the first extension 24 and the second extension 11 facing each other in the direction parallel to the optical axis (Z-axis). The carrier 23 may be moved relative to the housing 10, and thus there is a risk that the first extension 24 and the second extension 11 may collide with each other during the movement of the carrier 23. However, it is possible to alleviate an impact and a noise by disposing the buffer member on either one or both of the surfaces of the first extension 24 and the second extension 11 facing each other in the direction parallel to the optical axis (Z-axis).

An image sensor module 40 may be mounted on the bottom of the housing 10.

The image sensor module 40 may include an image sensor 41 having an imaging surface and a printed circuit board 43 connected to the image sensor 41, and may further include an infrared filter (not shown).

The infrared filter may serve to cut off light in an infrared region in light incident thereto through the lens module 20 to prevent the light in the infrared region from reaching the image sensor 41.

The image sensor 41 may convert light incident thereto through the lens module 20 into an electrical signal. For example, the image sensor 41 may be a charge-coupled device (CCD) or a complementary metal-oxide semiconductor (CMOS) device.

The electrical signal converted by the image sensor 41 may be output as an image through a display unit of a portable electronic device in which the camera module 1 is mounted.

The image sensor 41 may be mounted on the printed circuit board 43, and electrically connected to the printed circuit board 43 by wire bonding.

The second extension 24 may protrude from the lower surface of the housing 10, and the printed circuit board 43 may thus include a clearance region 44 to provide a space into which the second extension 24 may protrude (see FIG. 2).

For example, the printed circuit board 43 may have an open region corresponding to the second extension 11 of the housing 10 in the optical axis (Z-axis) direction. The open region may function as the clearance region 44, and the second extension 11 may be disposed in the clearance region 44.

The clearance region 44 may be a through-hole passing through the printed circuit board 43 in the optical axis (Z-axis) direction, or a recess in the upper surface of the printed circuit board 43.

Therefore, the first or second extension 24 or 11 may not overlap the printed circuit board 43 even though the first extension 24 protrudes from the lower surface of the carrier 23 and the second extension 11 protrudes from the lower surface of the housing 10, and the camera module 1 may thus have the overall height made smaller.

At least one of the plurality of balls included in the first ball unit B1 may be positioned below the imaging surface of the image sensor 41 in the direction parallel to the optical axis (Z-axis). For example, at least a portion of the ball positioned lowermost in the direction parallel to the optical axis (Z-axis) among the three balls included in the first ball unit B1 may be positioned below the imaging surface of the image sensor 41 as shown in FIG. 5.

The camera module 1 may detect a position of the carrier 23 in the optical axis (Z-axis) direction.

To this end, the camera module 1 may include a position sensor 37 (see FIGS. 2 and 4). The position sensor 37 may be disposed on the substrate 39 and face the magnet 31. The position sensor 37 may be a Hall sensor.

FIG. 6 is a modified example of a position of a magnet mounted on the carrier of the camera module of FIG. 1.

In an example embodiment, the magnet 31 may be disposed so that the action center point CP of the attractive force generated between the magnet 31 and the first yoke member 35 is positioned closer to the main guide including the first guide groove part G1 than to the auxiliary guide including the second guide groove part G2.

For example, referring to FIG. 6, the magnet 31 may be eccentric to one side on one side surface of the carrier 23 in a length direction (e.g., the first axis (X-axis) direction) of the magnet 31.

A center C1 of one side surface of the carrier 23 and a center C2 of the magnet 31 may be displaced from each other. The magnet 31 may be eccentric toward the main guide including the first guide groove part G1.

That is, the magnet 31 may be disposed closer to the main guide than to the auxiliary guide including the second guide groove part G2. The center of the magnet 31 may thus be closer to the first ball unit B1 than to the second ball unit B2.

The support region A may have a greater height in the optical axis (Z-axis) direction closer to the main guide than to the auxiliary guide, and it is thus possible to more stably position the action center point CP of the attractive force within the support region A by disposing the magnet 31 closer to the main guide.

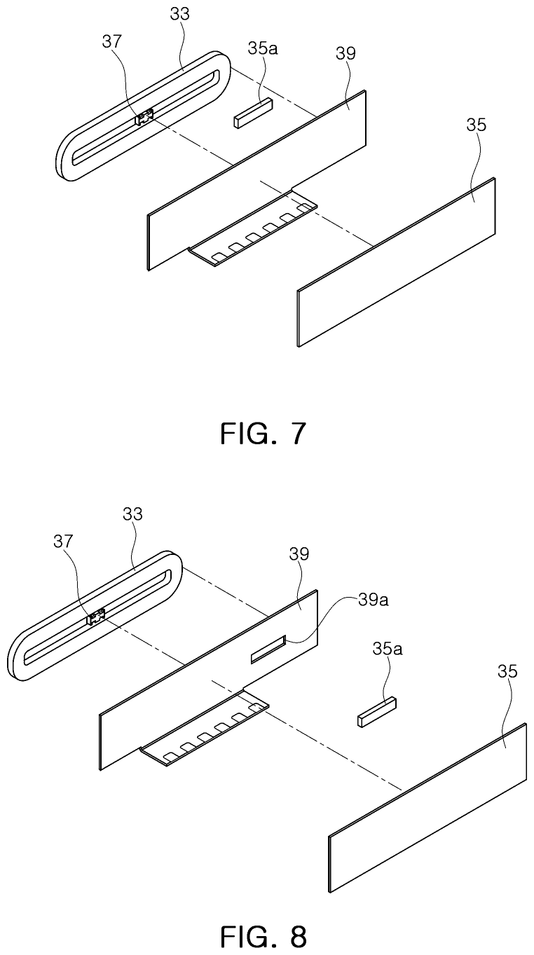

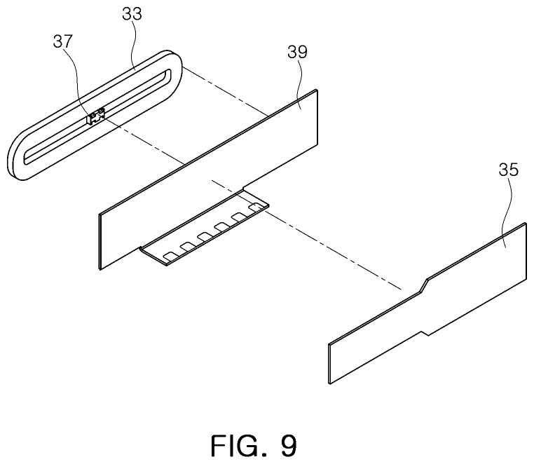

FIG. 7 is a view for explaining a second yoke member of the camera module of FIG. 1, and FIGS. 8 and 9 are modified examples of FIG. 7.

Referring to FIGS. 2 and 7, in an example embodiment, a second yoke member 35a may be disposed to face the magnet 31. The second yoke member 35a may be fixed to the housing 10. For example, the second yoke member 35a may be disposed on the substrate 39 and face the magnet 31.

The coil 33 and the second yoke member 35a may be disposed on one surface of the substrate 39, and a first yoke member 35 may be disposed on the other surface of the substrate 39.

As another example, referring to FIG. 8, the substrate 39 may include a through-hole 39a passing through the substrate 39, and the second yoke member 35a may be disposed in the through-hole 39a and directly face the magnet 31. Alternatively, the second yoke member 35a may be mounted on the first yoke member 35 and face the magnet 31 through the through-hole 39a.

The second yoke member 35a may be positioned closer to the main guide than to the auxiliary guide. For example, the second yoke member 35a may be positioned closer to the first ball unit B1 than to the second ball unit B2 (that is, closer to a ball unit including more balls).

The second yoke member 35a may be made of a material that may generate an attractive force with the magnet 31.

Therefore, a resultant force of the attractive force acting between the magnet 31 and the first yoke member 35 and the attractive force generated between the magnet 31 and the second yoke member 35 may be positioned closer to the main guide than to the auxiliary guide.

In another example embodiment, referring to FIG. 9, an area of a portion of the first yoke member 35 closer to the main guide relative to the center of the first yoke member 35 may be larger than an area of a portion of the first yoke member 35 closer to the auxiliary guide.

Therefore, an attractive force acting between the magnet 31 and the first yoke member 35 may be positioned closer to the main guide than to the auxiliary guide.

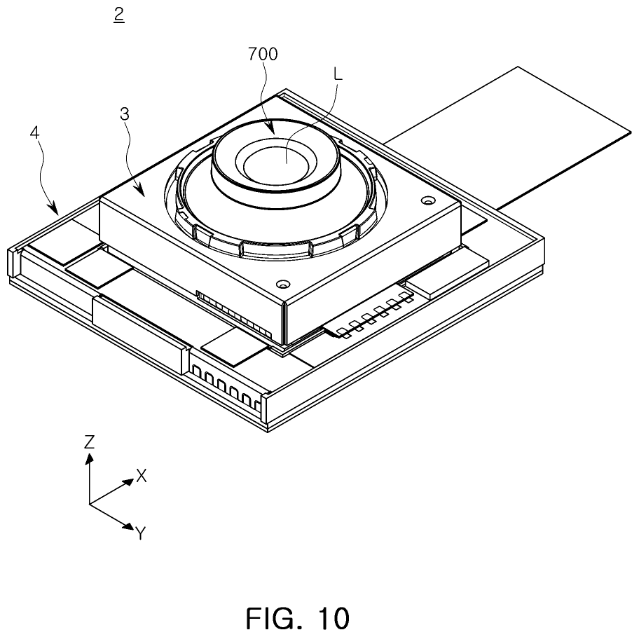

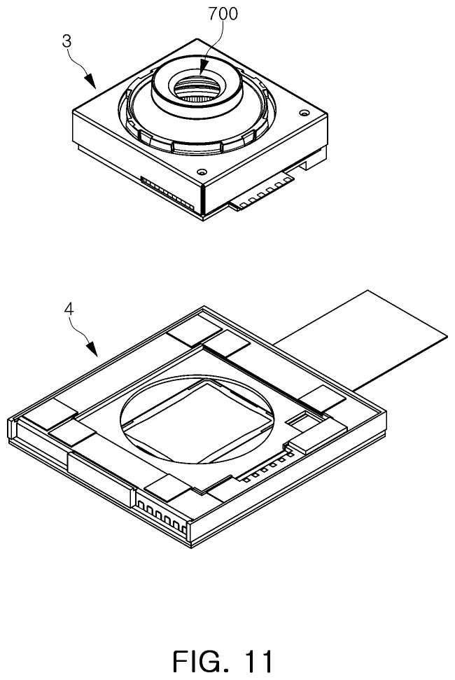

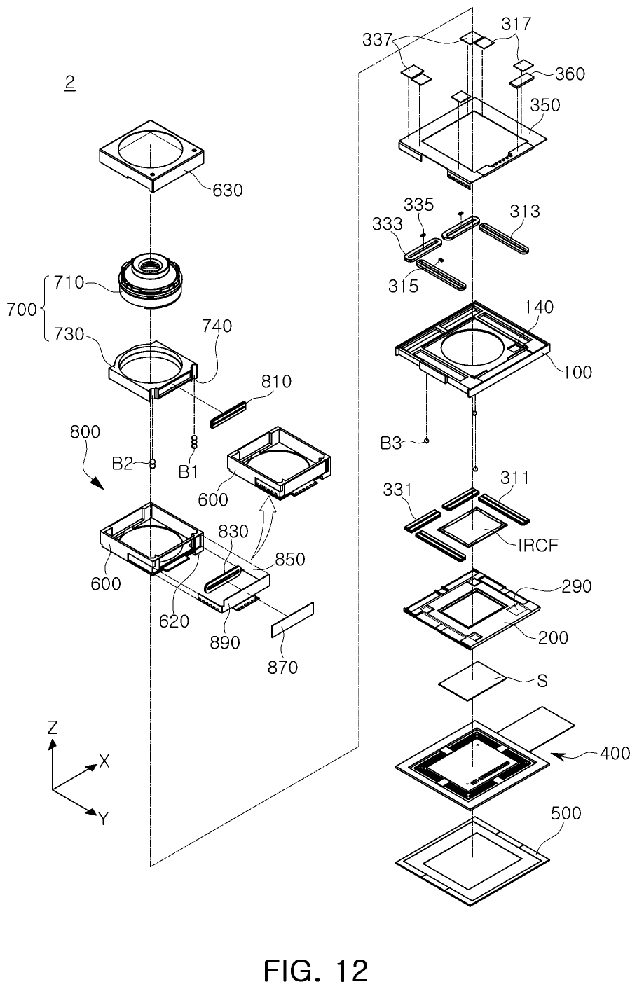

FIG. 10 is a perspective view of a camera module according to another example embodiment of the present disclosure; FIG. 11 is a view illustrating a first actuator and a second actuator of the camera module of FIG. 10 being separated from each other; and FIG. 12 is a schematic exploded perspective view of the camera module of FIG. 10.

Referring to FIGS. 10 to 12, a camera module 2 according to another example embodiment of the present disclosure may include a lens module 700, an image sensor S, a first actuator 3, and a second actuator 4.

The first actuator 3 is an actuator for autofocusing (AF), and the second actuator 4 is an actuator for optical image stabilization (OIS).

The lens module 700 may include at least one lens L and a lens barrel 710. The least one lens L may be disposed in the lens barrel 710. The lens module 700 may include a plurality of lenses L, and in this case, the plurality of lenses L may be mounted in the lens barrel 710 along an optical axis (Z-axis).

The lens module 700 may further include a carrier 730 coupled to the lens barrel 710.

The carrier 730 may include a through-hole passing through the carrier 730 in an optical axis (Z-axis) direction, and the lens barrel 710 may be inserted into the through-hole to be fixed to the carrier 730.

In this example embodiment, the lens module 700 may be a moving member moved in the optical axis (Z-axis) direction during the autofocusing (AF). To this end, the camera module 2 according to this example embodiment may include the first actuator 3.

The lens module 700 may be moved by the first actuator 3 in the optical axis (Z-axis) direction to perform the autofocusing (AF).

The lens module 700 may be a fixed member that is not moved during the optical image stabilization.

The camera module 2 according to this example embodiment may perform the optical image stabilization (OIS) by moving the image sensor S instead of the lens module 700. The image sensor S has a smaller weight than a weight of the lens module 700, and thus may be moved by a smaller driving force. The camera module 2 may thus perform the optical image stabilization more precisely.

To this end, the camera module 2 according to this example embodiment may include the second actuator 4.

The image sensor S may be moved by the second actuator 4 in a direction perpendicular to the optical axis (Z-axis) or rotated about the optical axis (Z-axis) as a rotation axis to stabilize the optical image.

That is, the image sensor S may be moved by the second actuator 4 in a direction perpendicular to a direction in which an imaging surface of the image sensor S is facing. For example, the image sensor S may be moved in the direction perpendicular to the optical axis (Z-axis) or rotated about the optical axis (Z-axis) as a rotation axis to stabilize the optical image.

In this specification, the optical axis (Z-axis) direction may be the direction in which the imaging surface of the image sensor S is facing. That is, the image sensor S may be moved in the direction perpendicular to the optical axis (Z-axis).

In the drawings of this specification, the image sensor S being moved in the direction perpendicular to the optical axis (Z-axis) may be understood as the image sensor S being moved in a direction parallel to the imaging surface.

In addition, the image sensor S being moved in a first axis (X-axis) direction or a second axis (Y-axis) direction may be understood as the image sensor S being moved in the direction perpendicular to the optical axis (Z-axis).

In addition, it is described that the image sensor S is rotated about the optical axis (Z-axis) as a rotation axis for convenience. However, the rotation axis when the image sensor S is rotated may not coincide with the optical axis (Z-axis). For example, the image sensor S may be rotated about any axis parallel to the direction in which the imaging surface of the image sensor S is facing as a rotation axis.

In addition, the first axis (X-axis) direction and the second axis (Y-axis) direction may be examples of two directions perpendicular to the optical axis (Z-axis) and intersecting each other. In this specification, the first axis (X-axis) direction and the second axis (Y-axis) direction may be understood as two directions perpendicular to the optical axis (Z-axis) and intersecting each other.

The lens module 700 may be moved in the optical axis (Z-axis) direction during the autofocusing (AF). To this end, the camera module 2 may include the first actuator 3.

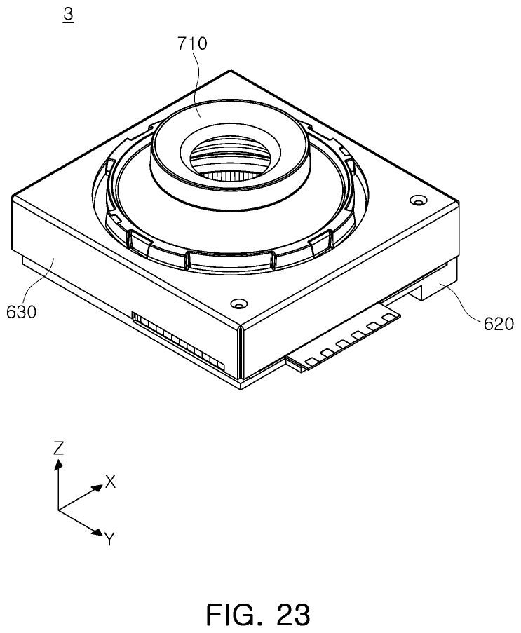

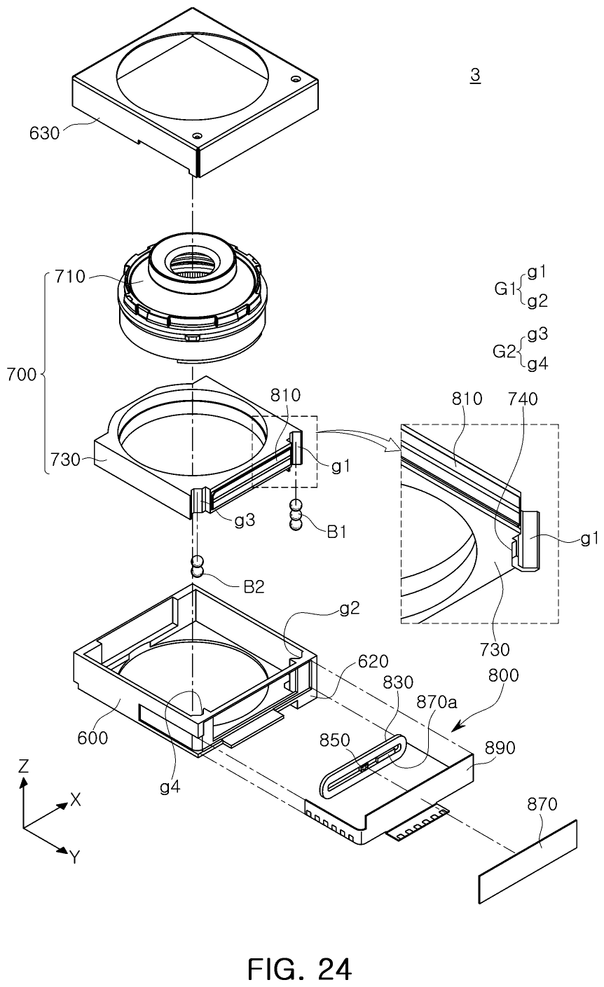

FIG. 23 is a perspective view of the first actuator of the camera module of FIG. 10, and FIG. 24 is an exploded perspective vie of the first actuator of the camera module of FIG. 10.

A configuration of the first actuator 3 may be similar to the configuration of the camera module 1 according to an example embodiment of the present disclosure described with reference to FIGS. 1 through 9, and accordingly a detailed description thereof is omitted.

However, the camera module 2 according to this example embodiment of the present disclosure is different from the camera module 1 according to an example embodiment of the present disclosure described with reference to FIGS. 1 through 9 in that the image sensor 41 of the camera module 1 may be mounted on the printed circuit board 43 and disposed on the bottom of the housing 10, whereas the image sensor S in the present camera module 2 may be mounted on a sensor substrate 400, and a portion of the sensor substrate 400 may be mounted on a moving frame 200.

In addition, a first driving unit 800 in this example embodiment may be the same as the driving unit 30 of the camera module 1 according to the camera module 1 according to the example embodiment described with reference to FIGS. 1 through 9. That is, in this example embodiment, the first driving unit 800 may generate a driving force in the optical axis (Z-axis) direction.

The first driving unit 800 may thus include a first magnet 810, a first coil 830, and may further include a first position sensor 850.

Referring to FIGS. 23 and 24, reference numbers identifying the parts of the first actuator 3 are different from the reference numbers identifying the corresponding parts of the camera module 1 according to an example embodiment of the present disclosure described with reference to FIGS. 1 through 9.

For example, the reference numbers identifying the lens module 700, the lens barrel 710, the carrier 730, a first extension 740, a housing 600, a second extension 620, a case 630, the first driving unit 800, the first magnet 810, the first coil 830, the first position sensor 850, a first yoke member 870, a second yoke member 870a, and a substrate 890 of this example embodiment are different from the reference numbers the lens module 20, the lens barrel 21, the carrier 23, the first extension 24, the housing 10, the second extension 11, the case 50, the driving unit 30, the magnet 31, the coil 33, the position sensor 37, the first yoke member 35, the second yoke member 35a, and the substrate 39 of the camera module 1 according to an example embodiment of the present disclosure described with reference to FIGS. 1 through 9.

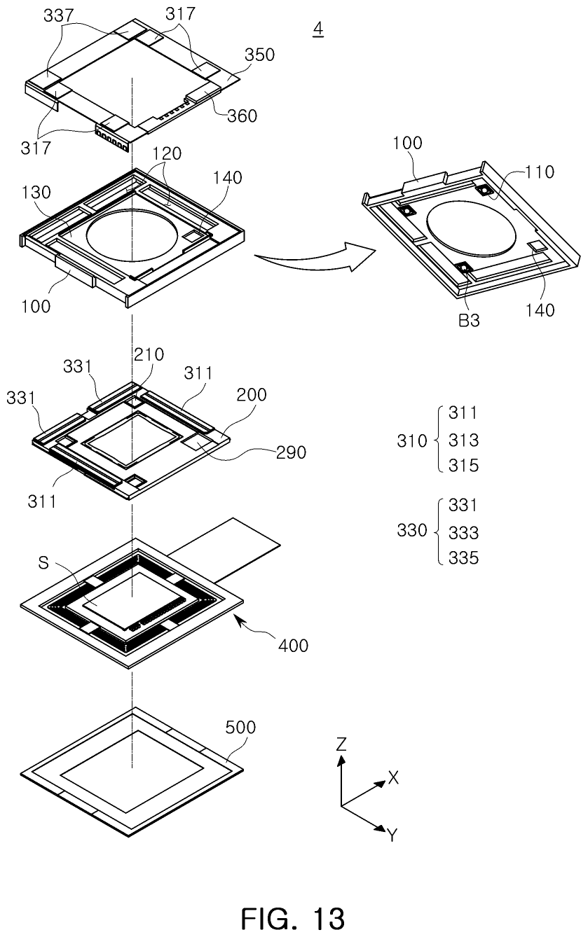

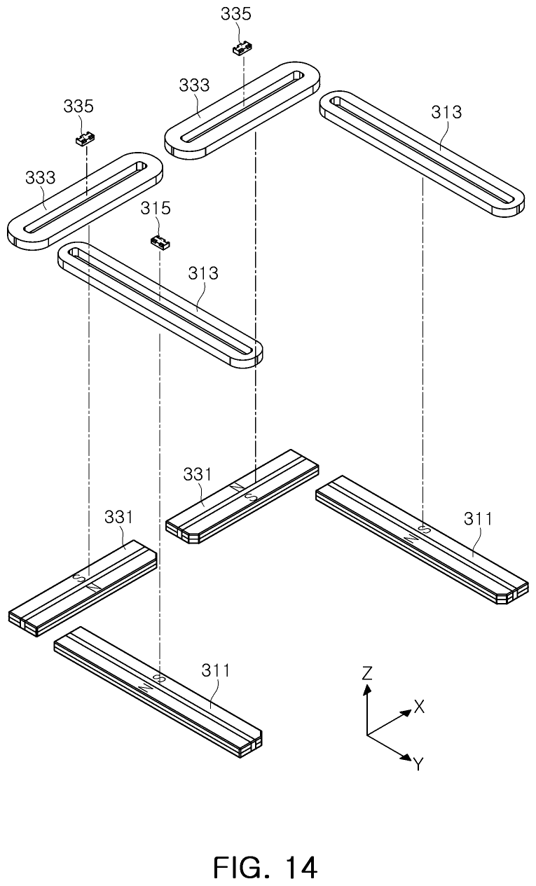

FIG. 13 is an exploded perspective view of the second actuator of the camera module of FIG. 10, and FIG. 14 is an exploded perspective view of a second driving unit and a third driving unit of the second actuator of the camera module of FIG. 10.

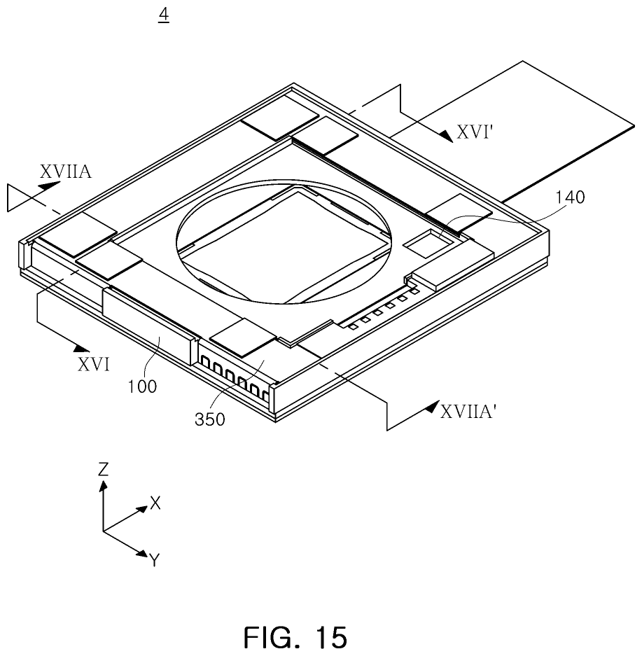

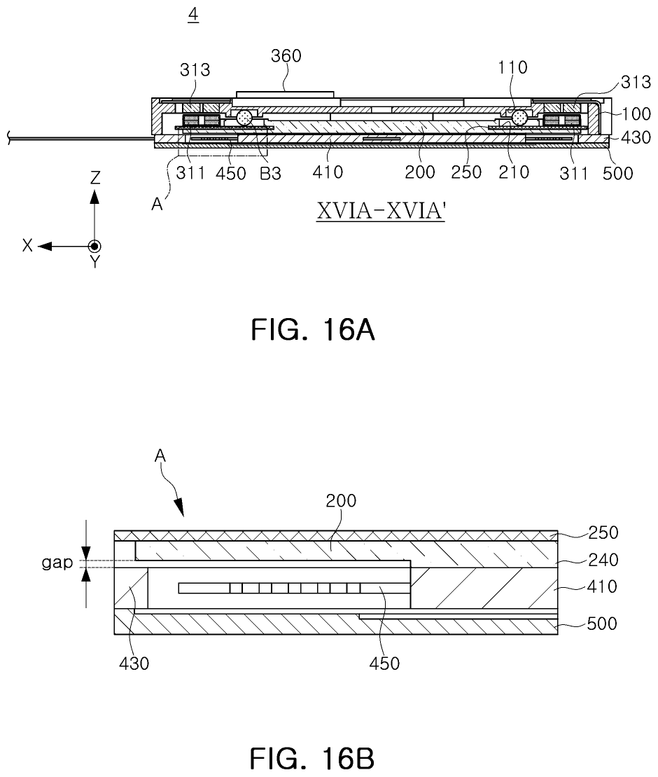

FIG. 15 is a perspective view of the second actuator of the camera module of FIG. 10; FIG. 16A is a cross-sectional view taken along the line XVIA-XVIA′ of FIG. 15, and FIG. 16B is an enlarged view of a portion A of FIG. 16A.

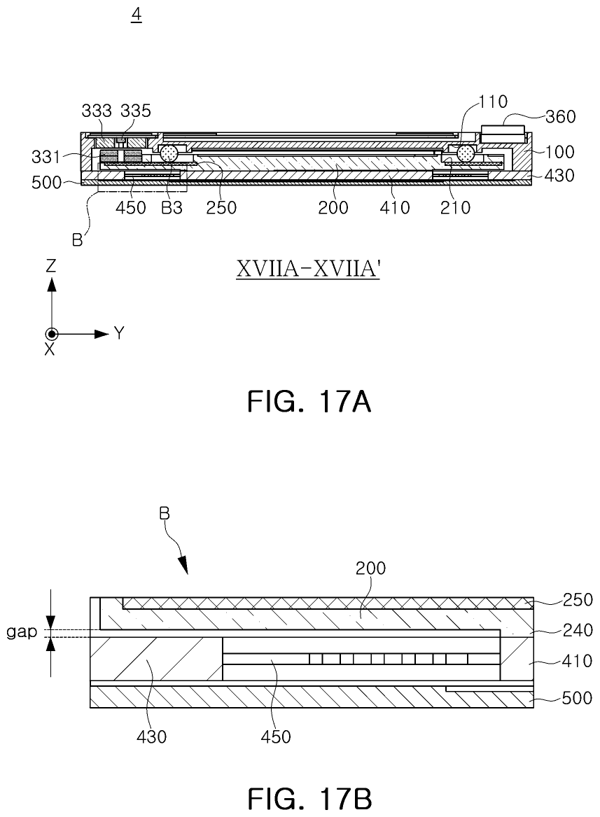

FIG. 17A is a cross-sectional view taken along the line XVIIA-XVIIA′ of FIG. 15, and FIG. 17B is an enlarged view of a portion B of FIG. 17A.

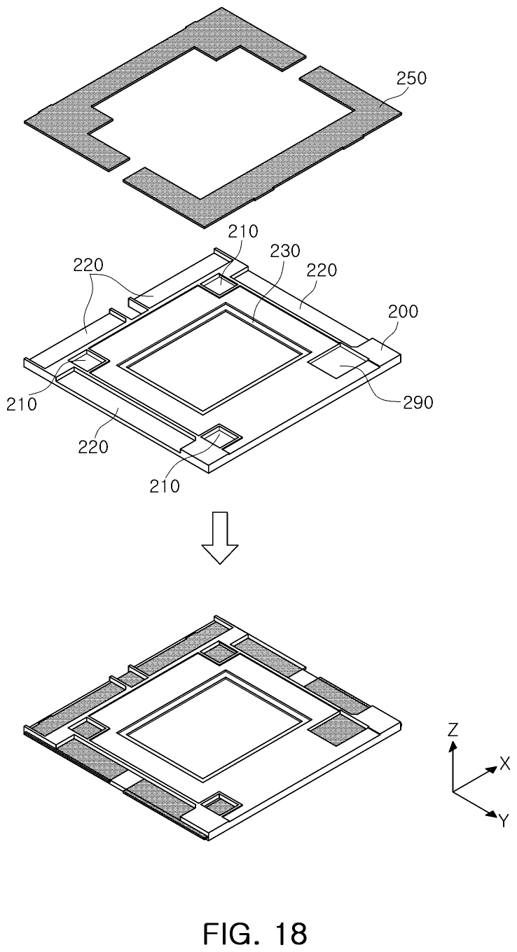

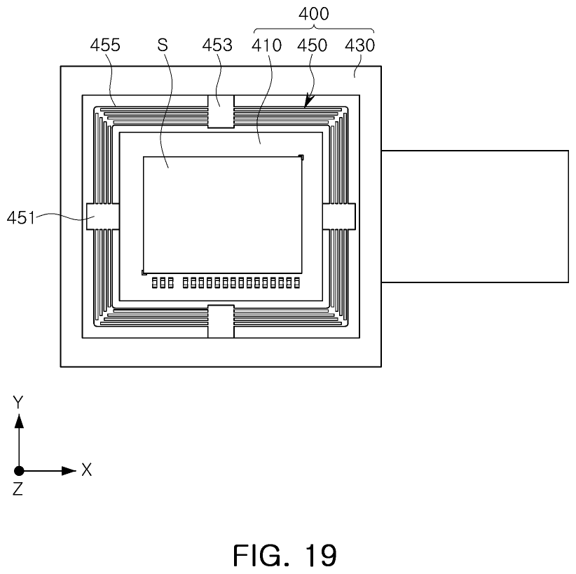

FIG. 18 is an example of a moving frame of the second actuator of the camera module of FIG. 10, and FIG. 19 is a plan view of a sensor substrate of the second actuator of the camera module of FIG. 10.

Hereinafter, the movement of the image sensor S is described with reference to FIGS. 13 through 19.

First, referring to FIG. 13, the second actuator 4 may include a fixed frame 100, the moving frame 200, a second driving unit 310, a third driving unit 330, and a sensor substrate 400, and may further include a base 500.

The fixed frame 100 may be coupled to the first actuator 3. For example, the fixed frame 100 may be coupled to the housing 600 of the first actuator 3. A seating recess 130 in which the housing 600 of the first actuator 3 is seated may be formed in an upper surface of the fixed frame 100.

The housing 600 of the first actuator 3 may have a second extension 620 protruding in a direction parallel to the optical axis (Z-axis), and the fixed frame 100 may include a clearance region in which the protruding second extension 620 is disposed.

For example, the fixed frame 100 may include a first accommodation part 140 as a clearance region. The first accommodation part 140 may be a recess formed in the upper surface of the fixed frame 100, or a through-hole passing through the fixed frame 100 in the optical axis (Z-axis) direction.

The second extension 620 may be disposed in the first accommodation part 140 when the first actuator 3 and the second actuator 4 are coupled to each other.

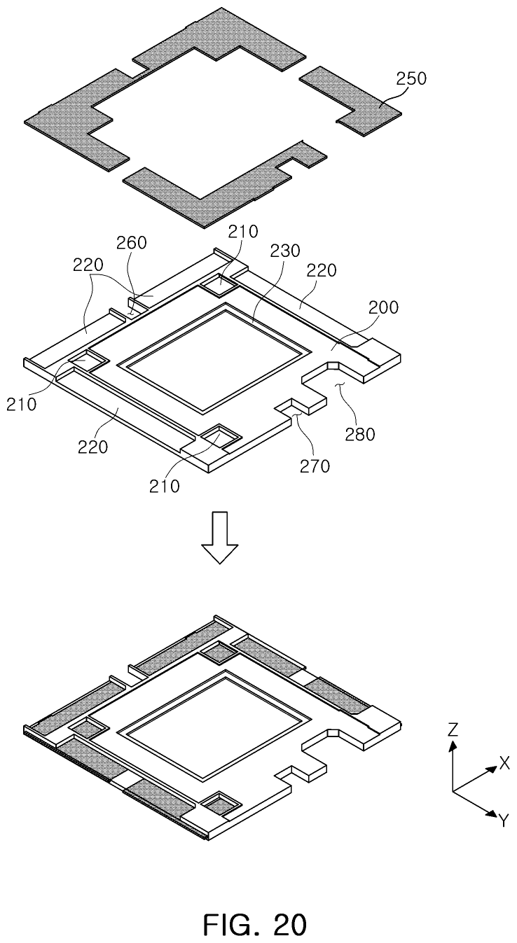

In another example, the moving frame 200 disposed below the fixed frame 100 in the optical axis (Z-axis) direction may include a second accommodation part 280 or 290 (see FIGS. 18 and 20). In this case, the first accommodation part 140 and the second accommodation part 280 or 290 may overlap each other in the optical axis (Z-axis) direction. The first accommodation part 140 may be a through-hole passing through the fixed frame 100 in the optical axis (Z-axis) direction, and the second accommodation part 280 or 290 may be a recess formed in the upper surface of the moving frame 200, or a through-hole passing through the moving frame 200 in the optical axis (Z-axis) direction.

In addition, the second extension 620 may be disposed in the first accommodation part 140 and the second accommodation part 280 or 290 when the first actuator 3 and the second actuator 4 are coupled to each other. The moving frame 200 may be a component that is moved in an X-Y plane, and a size of the second accommodation part 280 or 290 in the X-Y plane may be larger than a size of the second extension 620 in the X-Y plane by an amount sufficient to accommodate the movement of the moving frame 200.

In this way, the first actuator 3 may be disposed on the second actuator 4 even though the first actuator 3 has the first extension 740 protruding from a lower surface of the carrier 730 and the second extension 620 protruding from a lower surface of the housing 600, thereby preventing the camera module 2 from having an increased overall height as a result.

The fixed frame 100 may be a fixed member that is not moved during the autofocusing and the optical image stabilization.

The fixed frame 100 may have a shape of a rectangular box having an open top and an open bottom.

The moving frame 200 may be disposed in the fixed frame 100. The fixed frame 100 may have a sidewall extending downward in the optical axis (Z-axis) direction, and thus have an accommodation space for accommodating the moving frame 200.

The moving frame 200 may be moved relative to the fixed frame 100 in the direction perpendicular to the optical axis (Z-axis), or rotated about the optical axis (Z-axis) or an axis parallel to the optical axis (Z-axis) as a rotation axis. That is, the moving frame 200 may be a moving member that is moved during the optical image stabilization.

For example, the moving frame 200 may be moved in the first axis (X-axis) direction or the second axis (Y-axis) direction, and rotated about the optical axis (Z-axis) or an axis parallel to the optical axis (Z-axis) as a rotation axis.

The first axis (X-axis) direction may be a direction perpendicular to the optical axis (Z-axis), and the second axis (Y-axis) direction may be a direction perpendicular to both the optical axis (Z-axis) direction and the first axis (X-axis) direction.

The moving frame 200 may be a rectangular plate having through-hole in the optical axis (Z-axis) direction.

An infrared cut filter IRCF may be mounted on an upper surface of the moving frame 200. A filter mounting recess 230 in which the infrared cut filter IRCF is mounted may be formed in the upper surface of the moving frame 200 (see FIG. 18). The sensor substrate 400 may be mounted on a lower surface of the moving frame 200. A third ball unit B3 may be disposed between the fixed frame 100 and the moving frame 200.

The third ball unit B3 may be disposed to be in contact with each of the fixed frame 100 and the moving frame 200.

The third ball unit B3 may roll between the fixed frame 100 and the moving frame 200 to support the movement of the moving frame 200 when the moving frame 200 is moved or rotated relative to the fixed frame 100.

The moving frame 200 may be disposed in the fixed frame 100, and it is thus necessary to reduce a thickness of the moving frame 200 to reduce a height of the second actuator 4 in the optical axis (Z-axis) direction.

However, the moving frame 200 having the reduced thickness may have a reduced rigidity and therefore have a lower reliability against an external impact.

Accordingly, a reinforcing plate 250 may be disposed in or on the moving frame 200 to reinforce the rigidity of the moving frame 200.

For example, referring to FIG. 18, the reinforcing plate 250 may be integrally coupled to the moving frame 200 by insert injection molding. In this case, the reinforcing plate 250 may be integrated with the moving frame 200 during manufacturing by injecting a resin material into a mold in a state in which the reinforcing plate 250 is fixed in the mold.

The reinforcing plate 250 may be disposed on the moving frame 200. In addition, the reinforcing plate 250 may be partially exposed externally from the moving frame 200. In this way, it is possible to improve a coupling force between the reinforcing plate 250 and the moving frame 200, and prevent the reinforcing plate 250 from being separated from the moving frame 200 by partially exposing the reinforcing plate 250 externally from the moving frame 200 when the reinforcing plate 250 is integrally coupled to the moving frame 200 by the insert injection molding.

The reinforcing plate 250 may be made of stainless steel.

The image sensor S may be mounted on the sensor substrate 400. A portion of the sensor substrate 400 may be coupled to the moving frame 200, and another portion of the sensor substrate 400 may be coupled to the fixed frame 100.

The image sensor S may be mounted on the portion of the sensor substrate 400 that is coupled to the moving frame 200.

A portion of the sensor substrate 400 may be coupled to the moving frame 200, and a portion of the sensor substrate 400 may thus also be moved or rotated together with the moving frame 200 as the moving frame 200 is moved or rotated.

Therefore, the image sensor S may be moved or rotated on a plane perpendicular to the optical axis (Z-axis) to perform the optical image stabilization while capturing an image.

The second driving unit 310 or the third driving unit 330 may generate a driving force in the direction perpendicular to the optical axis (Z-axis) to move the moving frame 200 in the direction perpendicular to the optical axis (Z-axis), or rotate the moving frame 200 about the optical axis (Z-axis) or an axis parallel to the optical axis (Z-axis) as a rotation axis.

The second driving unit 310 may generate a driving force in the first axis (X-axis) direction, and the third driving unit 330 may generate a driving force in the second axis (Y-axis) direction.

The second driving unit 310 may include a second magnet 311 and a second coil 313. The second magnet 311 and the second coil 313 may be disposed to face each other in the optical axis (Z-axis) direction.

The second magnet 311 may be mounted on the moving frame 200. The second magnet 311 may include a plurality of magnets. For example, the second magnet 311 may include two magnets, and the two magnets may be symmetrically spaced apart from each other with respect to the optical axis (Z-axis). For example, the second magnet 311 may include the two magnets spaced apart from each other in the direction (e.g., the first axis (X-axis) direction) in which the driving force is generated by the second magnet 311.

Mounting recesses 220 in which the second magnet 311 is mounted may be formed in the upper surface of the moving frame 200 (see FIG. 18). The second magnet 311 may be inserted into the mounting recesses 220, thereby preventing each of the second actuator 4 and the camera module 2 from having an increased overall height due to a thickness of the second magnet 311.

The second magnet 311 may be magnetized so that one surface (e.g., a surface facing the second coil 313) thereof has both an N pole and an S pole. For example, the N pole, a neutral region, and the S pole may be sequentially arranged in the first axis (X-axis) direction on the one surface of the second magnet 311 facing the second coil 313. The second magnet 311 may be elongated in the second axis (Y-axis) direction (see FIG. 14).

The other surface (e.g., a surface opposite to the one surface) of the second magnet 311 may be magnetized to have both an S pole and an N pole. For example, the S pole, a neutral region, and the N pole may be sequentially arranged in the first axis (X-axis) direction on the other surface of the second magnet 311 so that the S pole on the other surface opposes the N pole on the one surface, and the N pole on the other surface opposes the S pole on the one surface.

The two magnets of the second magnet 311 may have the same magnetization direction in the first axis (X-axis) direction. That is, the N pole and the S pole of each of the two magnets of the second magnet 311 may be arranged in the same order in the first axis (X-axis direction).

The second coil 313 may be disposed to face the second magnet 311. For example, the second coil 313 may be disposed to face the second magnet 311 in the optical axis (Z-axis) direction.

The second coil 313 may have a hollow donut shape, and may be elongated in the second axis (Y-axis) direction. The second coil 313 may include a plurality of coils. A number of the coils included in the second coil 313 may be equal to a number of the magnets included in the second magnet 311.

The second coil 313 may be disposed on a first substrate 350. The first substrate 350 may be mounted on the fixed frame 100 so that the second magnet 311 and the second coil 313 face each other in the optical axis (Z-axis) direction.

The fixed frame 100 may include through-holes 120. For example, the through-holes 120 may pass through the fixed frame 100 in the optical axis (Z-axis) direction. The second coil 313 may be disposed in the through-holes 120 of the fixed frame 100, thereby preventing each of the second actuator 4 and the camera module 2 from having an increased overall height due to a thickness of the second coil 313.

The top of the through-holes 120 in the fixed frame 100 may be covered by the first substrate 350.

The second magnet 311 may be a moving member that is mounted on the moving frame 200 and moved together with the moving frame 200, and the second coil 313 may be a fixed member that is fixed to the first substrate 350 and the fixed frame 100.

In another example, the positions of the second magnet 311 and the second coil 313 may be reversed. For example, the second coil 313 may be a moving member that is mounted on the moving frame 200 and moved together with the moving frame 200, and the second magnet 311 may be a fixed member that is fixed to the fixed frame 100.

The moving frame 200 may be moved in the first axis (X-axis) direction by an electromagnetic force generated between the second magnet 311 and the second coil 313 when power is applied to the second coil 313.

The second magnet 311 and the second coil 313 may generate a driving force in a direction (e.g., the first axis (X-axis) direction) perpendicular to the direction (e.g., the optical axis (Z-axis) direction) in which the second magnet 311 and the second coil 313 face each other.

The third driving unit 330 may include a third magnet 331 and a third coil 333. The third magnet 331 and the third coil 333 may be disposed to face each other in the optical axis (Z-axis) direction.

The third magnet 331 may be mounted on the moving frame 200. The third magnet 331 may include a plurality of magnets. For example, the third magnet 331 may include two magnets, and the two magnets may be spaced apart from each other in the first axis (X-axis) direction. For example, the third magnet 331 may include the two magnets spaced apart from each other in a direction (e.g., the first axis (X-axis) direction) perpendicular to the direction (e.g., the second axis (Y-axis) direction) in which the driving force is generated by the third magnet 331.

In another example, the positions of the second magnet 311 and the third magnet 331 may be reversed from their positions shown in FIG. 13. For example, the second magnet 311 may include two magnets spaced apart from each other in a direction (the second axis (Y-axis) perpendicular to the direction (the first axis (X-axis) direction) in which the driving force is generated by the second magnet 311, and the third magnet 331 may include two magnets spaced apart from each other in the direction (the second axis (Y-axis) direction) in which the driving force is generated by the third magnet 331.

Alternatively, the second magnet 311 and the third magnet 331 may each include two magnets spaced apart from each other in a direction perpendicular to the direction in which the driving force is generated by each of the second magnet 311 and the third magnet 331.

Additional mounting recesses 220 in which the third magnet 331 is mounted may be formed in the upper surface of the moving frame 200 (see FIG. 18). The third magnet 331 may be inserted into the mounting additional recesses 220, thereby preventing each of the second actuator 4 and the camera module 2 from having an increased overall height due to a thickness of the third magnet 331.

The third magnet 331 may be magnetized so that one surface (e.g., a surface facing the third coil 333) thereof has both an S pole and an N pole. For example, the S pole, a neutral region, and the N pole may be sequentially arranged in the second axis (Y-axis) direction on the one surface of the third magnet 331 facing the third coil 333 (see FIG. 14). The third magnet 331 may be elongated in the first axis (X-axis) direction.

The other surface (e.g., a surface opposite to the one surface) of the third magnet 331 may be magnetized to have both a N pole and a S pole. For example, the N pole, a neutral region, and the S pole may be sequentially arranged in the second axis (Y-axis) direction on the other surface of the third magnet 331 so that the N pole on the other surface opposes the S pole on the one surface, and the S pole on the other surface opposes the N pole on the one surface.

The two magnets of the third magnet 331 may have opposite magnetization directions in the second axis (Y-axis) direction. That is, the N pole and the S pole of each of the two magnets of the third magnet 311 may be arranged in opposite orders in the second axis (Y-axis direction).

The third coil 333 may be disposed to face the third magnet 331. For example, the third coil 333 may be disposed to face the third magnet 331 in the optical axis (Z-axis) direction.

The third coil 333 may have a hollow donut shape, and may be elongated in the first axis (X-axis) direction. The third coil 333 may include a plurality of coils. A number of the coils included in the third coil 333 may be equal to a number of the magnets included in the third magnet 331.

The third coil 333 may be disposed on the first substrate 350. The first substrate 350 may be mounted on the fixed frame 100 so that the third magnet 331 and the third coil 333 face each other in the optical axis (Z-axis) direction.

The fixed frame 100 may include additional through-holes 120. For example, the additional through-holes 120 may pass through the fixed frame 100 in the optical axis (Z-axis) direction. The third coil 333 may be disposed in the additional through-holes 120 of the fixed frame 100, thereby preventing each of the second actuator 4 and the camera module 2 from having an increased overall height due to a thickness of the third coil 333.

The third magnet 331 may be a moving member that is mounted on the moving frame 200 and moved together with the moving frame 200, and the third coil 333 may be a fixed member that is fixed to the first substrate 350 and the fixed frame 100.

In another example, the positions of the third magnet 331 and the third coil 333 may be reversed. For example, the third coil 333 may be a moving member that is mounted on the moving frame 200 and moved together with the moving frame 200, and the third magnet 331 may be a fixed member that is fixed to the fixed frame 100.

The moving frame 200 may be moved in the second axis (Y-axis) direction by an electromagnetic force generated between the third magnet 331 and the third coil 333 when power is applied to the third coil 333.

The third magnet 331 and the third coil 333 may generate a driving force in a direction (e.g., the second axis (Y-axis) direction) perpendicular to the direction (the optical axis (Z-axis) direction) in which the third magnet 331 and the third coil 333 face each other.

In addition, the moving frame 200 may be rotated about the optical axis (Z-axis) or an axis parallel to the optical axis (Z-axis) by the second driving unit 310 and the third driving unit 330.

The second magnet 311 and the third magnet 331 may be disposed perpendicular to each other on the plane perpendicular to the optical axis (Z-axis), and the second coil 313 and the third coil 333 may also be disposed perpendicular to each other on the plane perpendicular to the optical axis (Z-axis).

A driver integrated circuit (IC) 360 (see FIGS. 12, 13, 16A, and 17A) may be disposed on the first substrate 350 to provide driving signals to the second coil 313 and the third coil 333.

The third ball unit B3 may be disposed between the fixed frame 100 and the moving frame 200.

The third ball unit B3 may be disposed to be in contact with each of the fixed frame 100 and the moving frame 200.

The third ball unit B3 may serve to guide the movement of the moving frame 200 during the optical image stabilization process. The third ball unit B3 may also serve to maintain a spacing between the fixed frame 100 and the moving frame 200.

The third ball unit B3 may roll in the first axis (X-axis) direction when the driving force is generated in the first axis (X-axis) direction. Therefore, the third ball unit B3 may guide the movement of the moving frame 200 in the first axis (X-axis) direction.

In addition, the third ball unit B3 may roll in the second axis (Y-axis) direction when the driving force is generated in the second axis (Y-axis) direction. Therefore, the third ball unit B3 may guide the movement of the moving frame 200 in the second axis (Y-axis) direction.

The third ball unit B3 may include a plurality of balls disposed between the fixed frame 100 and the moving frame 200.

Referring to FIG. 13, a plurality of guide grooves in which the third ball unit B3 is disposed may be formed in either one or both of a surface of the fixed frame 100 and a surface of the moving frame 200 facing each other in the optical axis (Z-axis) direction. The plurality of guide grooves may be disposed to correspond to the plurality of balls of the third ball unit B3.

For example, fifth guide grooves 110 may be formed in a lower surface of the fixed frame 100, and sixth guide grooves 210 may be formed in an upper surface of the moving frame 200.

The third ball unit B3 may be disposed in the fifth guide grooves 110 and the sixth guide grooves 210 and fitted between the fixed frame 100 and the moving frame 200.

Each of the fifth guide grooves 110 and the sixth guide grooves 210 may have a rectangular planar shape or a circular planar shape. Sizes of the fifth guide grooves 110 and the sixth guide grooves 210 may be larger than a diameter of the plurality of balls included in the third ball unit B3. For example, cross-sections of the fifth guide grooves 110 and the sixth guide grooves 210 on the plane perpendicular to the optical axis (Z-axis) may each have a size larger than the diameter of the plurality of balls included in the third ball unit B3.

The fifth guide grooves 110 and the sixth guide grooves 210 are not limited to any specific shape as long as their sizes are larger than the diameter of the third ball unit B3.

Accordingly, the third ball unit B3 may roll in the direction perpendicular to the optical axis (Z-axis) while being accommodated in the fifth guide grooves 110 and the sixth guide grooves 210.

The reinforcing plate 250 may be partially exposed externally through the upper surface of the moving frame 200. The reinforcing plate 250 externally exposed may be a bottom surface of the sixth guide grooves 210 (see FIGS. 16A, 17A, and 18). Therefore, the third ball unit B3 may roll in contact with the reinforcing plate 250.

As shown in FIG. 16A, the moving frame 200 may be moved in the first axis (X-axis) direction when the driving force is generated in the first axis (X-axis) direction.

In addition, as shown in FIG. 17A, the moving frame 200 may be moved in the second axis (Y-axis) direction when the driving force is generated in the second axis (Y-axis) direction.

In addition, the moving frame 200 may be rotated by generating a difference between a magnitude of the driving force generated in the first axis (X-axis) direction and a magnitude of the driving force generated in the second axis (Y-axis) direction.

A portion of the sensor substrate 400 may be coupled to the moving frame 200, and the image sensor S may be disposed on the portion of the sensor substrate 400 that is coupled to the moving frame 200. As a result, the image sensor S may also be moved or rotated as the moving frame 200 is moved.

Referring to FIGS. 16B and 17B, a protrusion 240 protruding toward the sensor substrate 400 may be disposed on the moving frame 200. For example, the protrusion 240 may be disposed on the lower surface of the moving frame 200, and the protrusion 240 may be coupled to a moving part 410 of the sensor substrate 400. Therefore, a gap may be formed between a body of the moving frame 200 and the sensor substrate 400 in the optical axis (Z-axis) direction, and thus interference between the moving frame 200 and the sensor substrate 400 may be prevented when the moving frame 200 is moved on the X-Y plane. As shown in FIGS. 16B and 17B, the substrate 400 also includes a fixed part 430 and a connection part 450. The substrate 400 will be described in greater detail later in connection with FIG. 19.

FIGS. 16B and 17B show that the protrusion 240 is disposed on the lower surface of the moving frame 200, which is only an example, and the protrusion 240 may alternatively be disposed on an upper surface of the sensor substrate 400.

The second actuator 4 may detect a position of the moving frame 200 in the direction perpendicular to the optical axis (Z-axis).

To this end, the second actuator 4 may include a second position sensor 315 and a third position sensor 335 (see FIG. 14). The second position sensor 315 may be disposed on the first substrate 350 to face the second magnet 311, and the third position sensor 335 may be disposed on the first substrate 350 to face the third magnet 331. The second position sensor 315 and the third position sensor 335 may be Hall sensors.

Referring to an example shown in FIG. 14, the third position sensor 335 may include two Hall sensors. For example, the third magnet 331 may include two magnets spaced apart from each other in the direction (e.g., the first axis (X-axis) direction) perpendicular to the direction (e.g., the second axis (Y-axis) direction) in which a driving force is generated by the third magnet 331, and the third position sensor 335 may include the two Hall sensors facing the two magnets.

The second actuator 4 may detect whether the moving frame 200 is rotated using the two Hall sensors facing the third magnet 331.

A rotational force may be intentionally generated by generating a difference between the driving force of the second driving unit 310 and the driving force of the third driving unit 330, using a resultant force of the second driving unit 310 and the third driving unit 330, or using the two magnets included in the third magnet 331 of the third driving unit 330.

The fifth guide grooves 110 and the sixth guide grooves 210 may each have a rectangular planar shape or a circular planar shape having a size larger than a diameter of the plurality of balls included in the third ball unit B3, and the third ball unit B3 disposed between the fifth guide grooves 110 and the sixth guide grooves 210 may roll without limitation in the direction perpendicular to the optical axis (Z-axis).

Accordingly, the moving frame 200 may be rotated about the optical axis (Z-axis) while being supported by the third ball unit B3.

In addition, the moving frame 200 may need a linear movement rather than a rotation. In this case, an unintentional rotational force acting on the moving frame 200 may be counteracted by controlling either one or both of the driving force of the second driving unit 310 and the driving force of the third driving unit 330 to counteract the unintentional rotational force.

Referring to FIG. 13, the second actuator 4 may include a first yoke 317 and a second yoke 337. The first yoke 317 and the second yoke 337 may generate attractive forces with the second magnet 311 and the third magnet 331 to enable the fixed frame 100 and the moving frame 200 to maintain contact with a first ball unit B3.

The first yoke 317 and the second yoke 337 may be disposed on the fixed frame 100. For example, the first yoke 317 and the second yoke 337 may be disposed on the first substrate 350, and the first substrate 350 may be coupled to the fixed frame 100.

The second coil 313 and the third coil 333 may be disposed on one surface of the first substrate 350, and the first yoke 317 and the second yoke 337 may be disposed on the other surface of the first substrate 350.

The first yoke 317 may be disposed to face the second magnet 311 in the optical axis (Z-axis) direction. The first yoke 317 may include a plurality of yokes. A number of the yokes included in the first yoke 317 may be equal to twice a number of the magnets included in the second magnet 311. For example, the first yoke 317 may include four yokes when the second magnet 311 includes two magnets. Each magnet included in the second magnet 311 may face two yokes included in the first yoke 317 in the optical axis (Z-axis) direction. The two yokes facing one magnet may be spaced apart from each other in the second axis (Y-axis) direction. Alternatively, the number of the yokes included in the first yoke 317 may be equal to the number of the magnets included in the second magnet 311. In this case, each magnet included in the second magnet 311 may face one yoke included in the first yoke 317 in the optical axis (Z-axis) direction.

The second yoke 337 may be disposed to face the third magnet 331 in the optical axis (Z-axis) direction. The second yoke 337 may include a plurality of yokes. A number of the yokes included in the second yoke 337 may be equal to a number of the magnets included in the third magnet 331. For example, the second yoke 337 may include two yokes when the third magnet 331 includes the a magnets. Each magnet included in the third magnet 331 may face one yoke included in the second yoke 337 in the optical axis (Z-axis) direction. The two yokes each facing one magnet may be spaced apart from each other in the first axis (X-axis) direction. Alternatively, the number of the yokes included in the second yoke 337 may be equal to twice the number of the magnets included in the third magnet 331. In this case, each magnet included in the third magnet 331 may face two yokes included in the second yoke 337 in the optical axis (Z-axis) direction. In this case, the two yokes facing one magnet may be spaced apart from each other in the first axis (X-axis) direction.

An attractive forces may be generated between the first yoke 317 and the second magnet 311 in the optical axis (Z-axis) direction, and an attractive force may be generated between the second yoke 337 and the third magnet 331 in the optical axis (Z-axis) direction.

Accordingly, the moving frame 200 may be pressed toward the fixed frame 100 by the attractive forces, and the fixed frame 100 and the moving frame 200 may thus be kept in contact with the third ball unit B3.

The first yoke 317 and the second yoke 337 may each be made of a material that may generate attractive forces with the second magnet 311 and the third magnet 331. For example, the first yoke 317 and the second yoke 337 may each be made of a magnetic material.

FIG. 19 is a plan view of a sensor substrate of the second actuator of the camera module of FIG. 10.

Referring to FIG. 19, the sensor substrate 400 may include the moving part 410, the fixed part 430, and the connection part 450 mentioned earlier in connection with FIGS. 16B and 17B. The sensor substrate 400 may be a rigid-flexible printed circuit board (RF PCB).

The image sensor S may be mounted on the moving part 410. The moving part 410 may be coupled to the lower surface of the moving frame 200. For example, the moving part 410 may have an area larger than an area of the image sensor S, and a portion of the moving part 410 outside a portion of the moving portion 410 on which the image sensor S is mounted may be coupled to the lower surface of the moving frame 200.

The moving part 410 may be a moving member that is moved together with the moving frame 200 during the optical image stabilization. The moving part 410 may be a rigid printed circuit board (RPCB).

The fixed part 430 may be coupled to the lower surface of the fixed frame 100. The fixed part 430 may be a fixed member that is not moved during the optical image stabilization. The fixed part 430 may be the rigid printed circuit board (RPCB).

The connection part 450 may be disposed between the moving part 410 and the fixed part 430, and connect the moving part 410 and the fixed part 430 to each other. The connection part 450 may be a flexible printed circuit board (FPCB). The connection part 450 disposed between the moving part 410 and the fixed part 430 may be bent when the moving part 410 is moved.

The connection part 450 may extend along a perimeter of the moving part 410. The connection part 450 may include a plurality of slits passing through the connection part 450 in the optical axis (Z-axis) direction. There may be a gap between a portion of the connection portion 450 in which the plurality of slits are formed and the moving part 410 and the fixed part 430. Accordingly, the connection part 450 may include a plurality of bridge elements 455 spaced apart from each other by the plurality of slits. The plurality of bridge elements 455 may extend along the perimeter of the moving part 410.

The connection part 450 may include a first support part 451 and a second support part 453. The connection part 450 may be connected to the moving part 410 through the first support part 451. In addition, the connection part 450 may be connected to the fixed part 430 through the second support part 453.

For example, the first support part 451 may be connected to the moving part 410, and spaced apart from the fixed part 430. In addition, the second support part 453 may be connected to the fixed part 430, and spaced apart from the moving part 410.

For example, the first support part 451 may extend in the first axis (X-axis) direction to connect the plurality of bridges 455 of the connection part 450 and the moving part 410 to each other. In an example embodiment, the first support part 451 may include two support parts disposed on opposite sides of the moving part 410 in the first axis (X-axis) direction.

The second support part 453 may extend in the second axis (Y-axis) direction to connect the plurality of bridges 455 of the connection part 450 and the fixed part 430 to each other. In an example embodiment, the second support part 453 may include two support parts disposed on opposite sides of the moving part 410 in the second axis (Y-axis) direction.

Accordingly, the moving part 410 may be moved in the direction perpendicular to the optical axis (Z-axis) or rotated about the optical axis (Z-axis) or an axis parallel to the optical axis (Z-axis) while being supported by the connection unit 450.

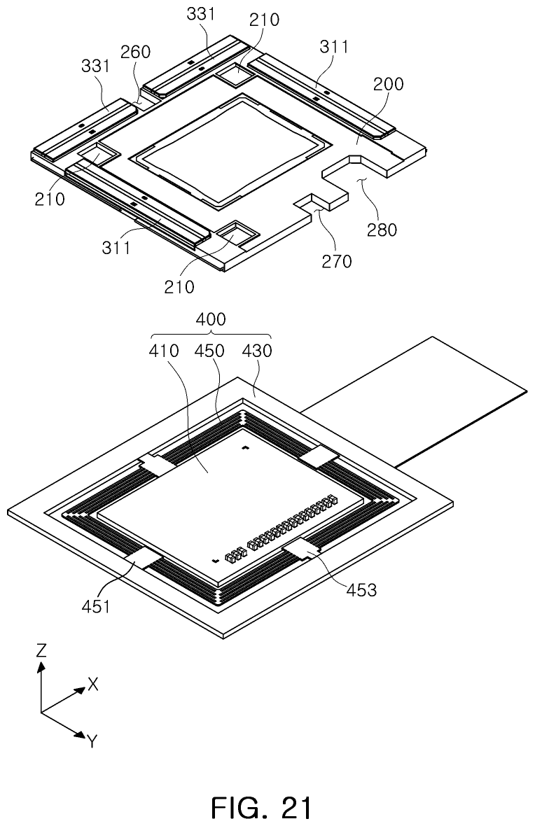

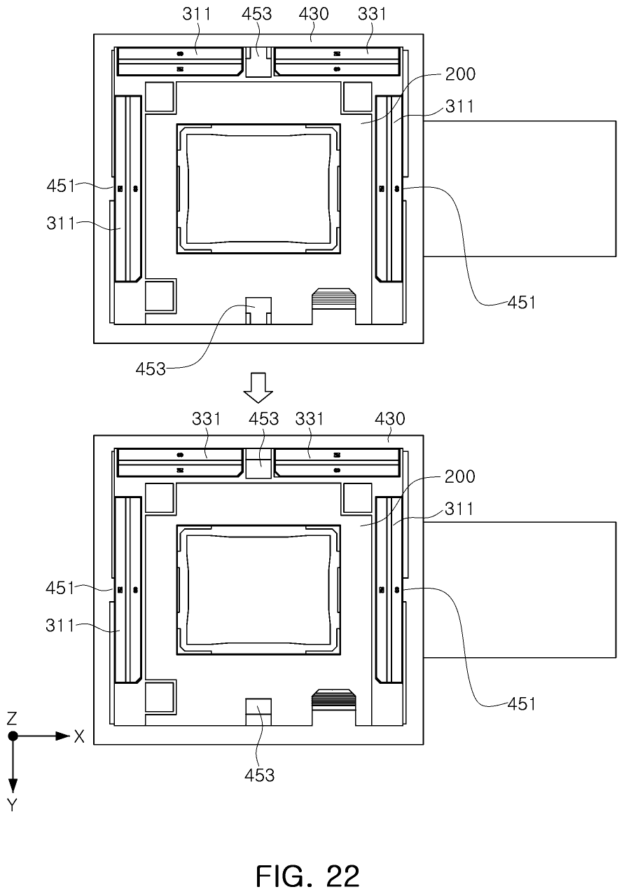

It is possible to reverse the positions of the components respectively connected to the first support part 451 and the second support part 453. For example, as shown in FIGS. 21 and 22, the first support part 451 may be connected to the fixed part 430 and spaced apart from the moving part 410, and the second support part 453 may be connected to the moving part 410 and spaced apart from the fixed part 430.

Referring again to FIG. 19, the plurality of bridges 455 connected to the first support part 451 may be bent when the image sensor S is moved in the first axis (X-axis) direction. In addition, the plurality of bridges 455 connected to the second support part 453 may be bent when the image sensor S is moved in the second axis (Y-axis) direction. In addition, the plurality of bridges 455 connected to the first support part 451 and the plurality of bridges 455 connected to the second support part 453 may be bent together when the image sensor S is rotated about the optical axis (Z-axis) or an axis parallel to the optical axis (Z-axis).

The base 500 may be coupled to the bottom of the sensor substrate 400.

The base 500 may be coupled to the sensor substrate 400 to cover the bottom of the sensor substrate 400. The base 500 may serve to prevent external foreign material from being introduced through a gap between the moving part 410 and the fixed part 430 of the sensor substrate 400.

FIG. 20 is a modified example of FIG. 18; FIG. 21 is a perspective view of the moving frame and the sensor substrate of the second actuator of the camera module of FIG. 10; and FIG. 22 is a plan view illustrating the moving frame and sensor substrate of the second actuator of the camera module of FIG. 10 being coupled to each other.

Referring to FIGS. 20 through 22, the moving frame 200 may include a first access hole 260 and a second access hole 270.

For example, the first access hole 260 and the second access hole 270 may pass through the moving frame 200 in the optical axis (Z-axis) direction.

The moving frame 200 may be coupled to the sensor substrate 400. In this state, the first access hole 260 and the second access hole 270 may each overlap a space between the fixed part 430 and connection part 450 of the sensor substrate 400 in the optical axis (Z-axis) direction.

That is, the space between the fixed part 430 and the connection part 450 may be exposed through the first access hole 260 and the second access hole 270 when viewed in the optical axis (Z-axis) direction as shown in FIG. 22.

The connection part 450 of the sensor substrate 400 may include the first support part 451 and the second support part 453. The connection part 450 may be connected to the fixed part 430 through the first support part 451. In addition, the connection part 450 may be connected to the moving part 410 through the second support part 453.

That is, the first support part 451 may be spaced apart from the moving part 410, and the second support part 453 may be spaced apart from the fixed part 430, and the plurality of bridges 455 of the connection part 450 may thus support the moving part 410 with fluidity.

However, it may be difficult to fix the position of the moving part 410 supported by the connection part 450 in a coupling process in a state in which the plurality of bridges 455 of the connection part 450 have the fluidity when coupling the sensor substrate 400 and the moving frame 200 to each other. This case may be highly likely to lead to an assembly failure, and the plurality of bridges 455 of the connection part 450 may be required to have no fluidity when coupling the sensor substrate 400 and the moving frame 200 to each other.

Accordingly, in an example embodiment, the sensor substrate 400 and the moving frame 200 may be coupled to each other in a state while either the first support part 451 or the second support part 453 is connected to all of the moving part 410, the fixed part 430 and the plurality of bridges 455 (see FIGS. 21 and 22).

In FIG. 21, the first support part 451 may be connected to the fixed part 430 and spaced apart from the moving part 410, and the second support part 453 may be connected to all of the moving part 410, the fixed part 430, and the plurality of bridges 455. Accordingly, the plurality of bridges 455 may have no fluidity in this state.

The moving part 410 and moving frame 200 of the sensor substrate 400 may be coupled to each other, and a portion where the second support part 453 and the fixed part 430 are connected to each other may then exposed through the first access hole 260 and the second access hole 270 of the moving frame 200 as shown in the top figure in FIG. 22.

Accordingly, the portion where the second support part 453 and the fixed part 430 are connected to each other may thus be cut through the first access hole 260 and the second access hole 270 as shown in the bottom figure in FIG. 22, and the moving part 410 of the sensor substrate 400 may thus have the fluidity after being coupled to the moving frame 200 (see FIG. 22).

In the camera module 2 according to another example embodiment of the present disclosure, the lens module 700 may be moved in the optical axis (Z-axis) direction during the autofocusing, and the image sensor S may be moved in the direction perpendicular to the optical axis (Z-axis) during the optical image stabilization.

The relative positions of the second magnet 311 and the second coil 313 of the second driving unit 310 and the relative positions of the third magnet 331 and the third coil 333 of the third driving unit 330 do not change when the lens module 700 is moved in the optical axis (Z-axis) direction during the autofocusing, thereby precisely controlling the driving force for the optical image stabilization.

In addition, the relative positions of the first magnet 810 and the first coil 830 of the first driving unit 800 do not change when the image sensor S is moved in the direction perpendicular to the optical axis during the optical image stabilization, thereby precisely controlling the driving force for the autofocusing.

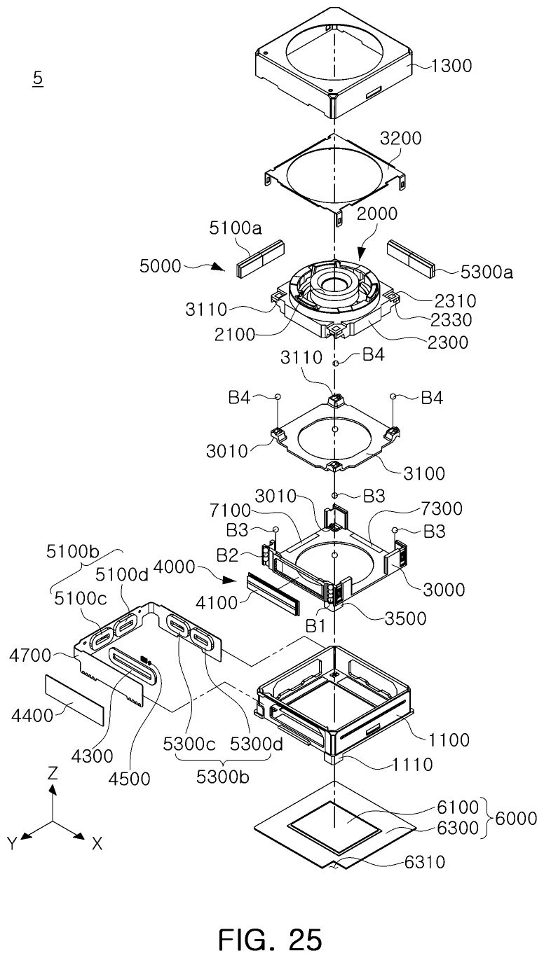

Hereinafter, a camera module 5 according to another example embodiment of the present disclosure is described with reference to FIGS. 25 through 30.

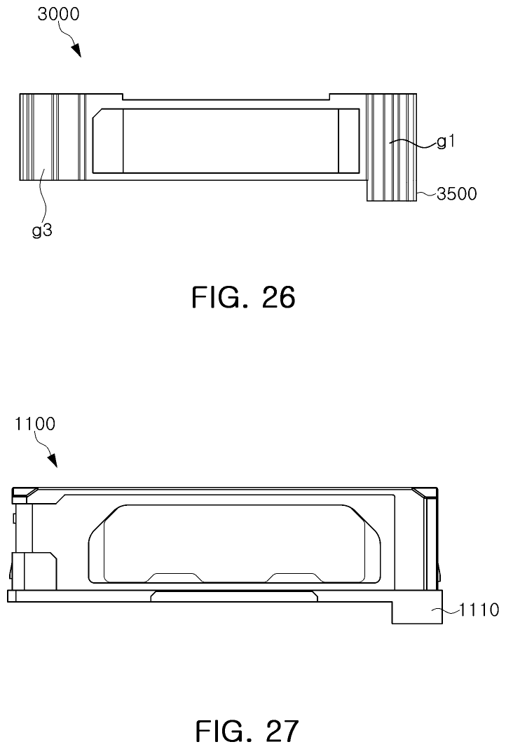

FIG. 25 is a schematic exploded perspective view of a camera module according to another example embodiment of the present disclosure; FIG. 26 is a front view of a carrier of the camera module of FIG. 25; and FIG. 27 is a front view of a housing of the camera module of FIG. 25.

Referring to FIGS. 25 through 27, a camera module 5 according to another example embodiment of the present disclosure may include a lens module 2000, a lens driving device for moving the lens module 2000, and a housing 1100 for accommodating the lens module 2000 and the lens driving device. In addition, the camera module 5 may further include an image sensor module 6000 for converting light incident thereto through the lens module 2000 into an electrical signal, and a case 1300 coupled to the housing 1100.

The lens module 2000 may include a lens barrel 2100 and a lens holder 2300.

The lens barrel 2100 may have a hollow cylindrical shape, and at least one lens for capturing a subject may be disposed in the lens barrel 2100. The lens module 2000 may include a plurality of lenses, and in this case, the plurality of lenses may be mounted in the lens barrel 2100 along an optical axis (Z-axis) of the lens barrel 2100.

The lens barrel 2100 may be coupled to the lens holder 2300. Accordingly, the lens barrel 2100 and the lens holder 2300 may be moved together.

For example, the lens module 2000 may be disposed in a carrier 3000, and the lens module 2000 may also be moved together with the carrier 3000 in an optical axis (Z-axis) direction as the carrier 3000 is moved in the optical axis (Z-axis) direction. In addition, the lens module 2000 may be moved relative to the carrier 3000 in the carrier 3000 in a direction perpendicular to the optical axis (Z-axis).

The lens driving device may be a device for moving the lens module 2000.

For example, the lens driving device may perform an autofocusing (AF) by moving the lens module 2000 in the optical axis (Z-axis) direction, and perform an optical image stabilization (01S) when capturing an image by moving the lens module 2000 in the direction perpendicular to the optical axis (Z-axis).

The lens driving device may include an autofocusing unit 4000 for performing the autofocusing and an optical image stabilization unit 5000 for stabilizing the optical image.

The image sensor module 6000 may be a device for converting light incident thereto through the lens module 2000 into an electrical signal.

For example, the image sensor module 6000 may include an image sensor 6100 and a printed circuit board 6300 on which the image sensor 6100 may be mounted, and may further include an infrared filter.

The infrared filter may serve to cut off light in an infrared region in light incident thereto through the lens module 2000 to prevent the light in the infrared region from reaching the image sensor 6100.

The image sensor 6100 may convert light incident thereto through the lens module 2000 into an electrical signal. For example, the image sensor 6100 may be a charge-coupled device (CCD) or a complementary metal-oxide semiconductor (CMOS) device.

The electrical signal converted by the image sensor 6100 may be output as an image through a display unit of a portable electronic device in which the camera module 5 is mounted.

The image sensor 6100 may be mounted on the printed circuit board 6300, and electrically connected to the printed circuit board 6300 by wire bonding.

The lens module 2000 may be disposed in the housing 1100. For example, the housing 1100 may have an open top and an open bottom, and the lens module 2000 may be disposed in an internal space of the housing 1100.

The image sensor module 6000 may be disposed on the bottom of the housing 1100.

The case 1300 may be coupled to the housing 1100 to surround outer surfaces of the housing 1100, and protect components in the camera module 5.

Referring to FIG. 25, the following description describes the autofocusing unit 4000 of the lens driving device.

The lens driving device may move the lens module 2000 to focus on the subject.

For example, the camera module according to another example embodiment of the present disclosure may include the autofocusing unit 4000 that moves the lens module 2000 in the optical axis (Z-axis) direction.

The autofocusing unit 4000 may include a carrier 3000 for accommodating the lens module 2000, and a first magnet 4100 and a first coil 4300 for generating a driving force to move the lens module 2000 and the carrier 3000 in the optical axis (Z-axis) direction.

The first magnet 4100 may be mounted on the carrier 3000. For example, the first magnet 4100 may be mounted on one side surface of the carrier 3000.

The first magnet 4100 may be magnetized so that one surface (e.g., a surface facing the first coil 4300) thereof has both an N pole and an S pole. For example, the N pole, a neutral region, and the S pole may be sequentially arranged in the optical axis (Z-axis) direction on the one surface of the first magnet 4100 facing the coil 4300.

The other surface (e.g., a surface opposite to the one surface) of the first magnet 4100 may be magnetized to have both an S pole and an N pole. For example, the S pole, a neutral region, and the N pole may be sequentially arranged in the optical axis (Z-axis) direction on the other surface of the first magnet 4100 so that the S pole on the other surface opposes the N pole on the one surface, and the N pole on the other surface opposes the S pole on the one surface.

The first coil 4300 may be disposed to face the first magnet 4100. For example, the first coil 4300 may be disposed to face the first magnet 4100 in a direction perpendicular to the optical axis (Z-axis).

The first coil 4300 may be disposed on a substrate 4700. For example, the first coil 4300 may be disposed on one surface of the substrate 4700. The substrate 4700 may be mounted on a side surface of the housing 1100 so that the first magnet 4100 and the first coil 4300 face each other in the direction perpendicular to the optical axis (Z-axis).

The housing 1100 may include an opening, and the first coil 4300 disposed on the substrate 4700 may thus directly face the first magnet 4100 through the opening.

The first magnet 4100 may be a moving member mounted on the carrier 3000 to thus be moved together with the carrier 3000 in the optical axis (Z-axis) direction, and the first coil 4300 may be a fixed member fixed to the housing 1100.

The carrier 3000 may be moved in the optical axis (Z-axis) direction by an electromagnetic force generated between the first magnet 4100 and the first coil 4300 when power is applied to the first coil 4300.

The lens module 2000 may be disposed in the carrier 3000, and the lens module 2000 may thus also be moved in the optical axis (Z-axis) direction as the carrier 3000 is moved in the optical axis (Z-axis) direction. As described below, a guide frame 3100 and the lens module 2000 are sequentially disposed in the carrier 3000, and the guide frame 3100 and the lens module 2000 may thus also be moved in the optical axis (Z-axis) direction as the carrier 3000 is moved in the optical axis (Z-axis) direction.

A first ball unit B1 and a second ball unit B2 may be disposed between the carrier 3000 and the housing 1100 to reduce friction between the carrier 3000 and the housing 1100 when the carrier 3000 is moved. The first ball unit B1 and the second ball unit B2 may be spaced apart from each other in a first axis (X-axis) direction perpendicular to the optical axis (Z-axis).

The first ball unit B1 and the second ball unit B2 may each include a plurality of balls disposed in a direction parallel to the optical axis (Z-axis). The plurality of balls may roll in the optical axis (Z-axis) direction when the carrier 3000 is moved in the optical axis (Z-axis) direction.

A first yoke member 4400 may be disposed on the housing 1100. The first yoke member 4400 may be disposed to face the first magnet 4100. For example, the first coil 4300 may be disposed on one surface of the substrate 4700, and the first yoke member 4400 may be disposed on the other surface (e.g., a surface opposite to the one surface) of the substrate 4700.

The first magnet 4100 and the first yoke member 4400 may generate an attractive force between each other. For example, the attractive force may act between the first magnet 4100 and the first yoke member 4400 in the direction perpendicular to the optical axis (Z-axis).

The first ball unit B1 and the second ball unit B2 may be kept in contact with the carrier 3000 and the housing 1100 by the attractive force acting between the first magnet 4100 and the first yoke member 4400.
Guide grooves may be formed in surfaces of the carrier 3000 and the housing 100 facing each other in the direction perpendicular to the optical axis (Z-axis). For example, a first guide groove part G1 may be formed in each of the surfaces of the carrier 3000 and the housing 1100 facing each other on one side of the carrier 3000 and the housing 1100 in the first axis (X-axis) direction perpendicular to the optical axis (Z-axis), and a second guide groove part G2 may be formed in each of the surfaces of the carrier 3000 and the housing 1100 facing each other on the other side of the carrier 3000 and the housing 1100 in the first axis (X-axis) direction perpendicular to the optical axis (Z-axis). Thus, the first guide groove part G1 and the second guide groove part G2 may be spaced apart from each other in the first axis (X-axis) direction perpendicular to the optical axis (Z-axis).

The first guide groove part G1 and the second guide groove part G2 are not shown in FIG. 25, but may be the same as the first guide groove part G1 including a first guide groove g1 and a second guide groove g2, and the second guide groove part G2 including a third guide groove g3 and a fourth guide groove g4, shown in FIGS. 2 and 24.

The first ball unit B1, the second ball unit B2, the first guide groove part G1, the second guide groove part G2, the first magnet 4100, the first yoke member 4400, and a second yoke member 4500 in FIG. 25 have the same configurations as the first ball unit B1, the second ball unit B2, the first guide groove part G1, the second guide groove part G2, the first magnet 31, the first yoke member 35, and the second yoke member 35a described with reference to FIGS. 1 through 9, and detailed descriptions thereof are omitted.

A first extension 3500 protruding in a direction parallel to the optical axis (Z-axis) may be disposed on the lower surface of the carrier 3000. The first guide groove g1 of the first guide groove part G1 in which the first ball unit B1 is disposed may have a length greater than a length of the third guide groove g3 of the second guide groove part G2 in which the second ball unit B2 is disposed by a length of the first extension 3500.

The first extension 3500 may protrude from the lower surface of the carrier 3000, and the center of gravity of the carrier 3000 may thus be positioned closer to the first guide groove g1 than to the third guide groove g3.

The first ball unit B1 may be disposed in the first guide groove g1 and the second ball unit B2 may be disposed in the third guide groove g3, and the center of gravity of the carrier 3000 may thus be positioned closer to the first ball unit B1 than to the second ball unit B2.

A second guide groove g2 of the first guide groove part G1 may protrude from the lower surface of the housing 1100 in a direction parallel to the optical axis (Z-axis). For example, a second extension 1110 protruding downward in the direction parallel to the optical axis (Z-axis) may be disposed on the lower surface of the housing 1100. The second guide groove g2 of the first guide groove part G1 may have a length greater than a length of a fourth guide groove g4 of the second guide groove part G2 by a length of the second extension 1110.

The second extension 1110 may protrude from the lower surface of the housing 1100, and the center of gravity of the housing 1100 may thus be positioned closer to the second guide groove g2 than to the fourth guide groove g4.

The first ball unit B1 may be disposed in the second guide groove g2 and the second ball unit B2 may be disposed in the fourth guide groove g4, and the center of gravity of the housing 1100 may thus be positioned closer to the first ball unit B1 than to the second ball unit B2.

The second extension 1110 may have an accommodation space for accommodating the first extension 3500, and at least a portion of the first extension 3500 may be accommodated in the second extension 1110.

The first extension 3500 and the second extension 1110 may have surfaces facing each other in the direction perpendicular to the optical axis (Z-axis), and at least one of the plurality of balls included in the first ball unit B1 may be disposed between the first extension 3500 and the second extension 1110. For example, a ball positioned at the lowermost side in the direction parallel to the optical axis (Z-axis) among the plurality of balls included in the first ball unit B1 may be disposed between the first extension 3500 and the second extension 1110.

The first guide groove part G1, which is part of a main guide, may have a length greater than a length of the second guide groove part G2, which is part of an auxiliary guide, and the camera module 5 may thus have a smaller size while a support region A (see FIG. 5) has a greater height in the optical axis (Z-axis) direction.

Through this configuration, the camera module 5 may achieve its slimness by having a smaller height in the optical axis (Z-axis) direction while securing a driving stability during the autofocusing.

The second extension 1110 may protrude from the lower surface of the housing 1100, and the printed circuit board 6300 may thus include a clearance region 6310 to provide a space into which the second extension 1110 may protrude.

For example, the printed circuit board 6300 may include an open region corresponding to the second extension 1110 of the housing 1100 in the optical axis (Z-axis) direction. The open region may function as the clearance region 6310, and the second extension 1110 may be disposed in the clearance region 6310.

The clearance region 6310 may be a through-hole passing through the printed circuit board 6300 in the optical axis (Z-axis) direction, or a recess formed in an upper surface of the printed circuit board 6300.

Therefore, the protruding portion of the first or second extension 3500 or 1110 may not overlap the printed circuit board 6300 even though the first extension 3500 protrudes from the lower surface of the carrier 3000 and the second extension 1110 protrudes from the lower surface of the housing 1100, and the camera module 5 may thus have its overall height made smaller.

Next, the following description describes the optical image stabilization unit 5000 the lens driving device according to another example embodiment of the present disclosure with reference to FIG. 25.

The optical image stabilization unit 5000 may be used to stabilize a blurred image or an unstable video due to a factor such as a user's hand trembling when capturing the image or the video.

For example, the image being captured may be unstable due to the user's hand trembling or other factor. The optical image stabilization unit 5000 may stabilize the image by moving the lens module 2000 to correspond to this unstableness.

For example, the optical image stabilization unit 5000 may move the lens module 2000 in a direction perpendicular to the optical axis (Z-axis) to stabilize the optical image.

The optical image stabilization unit 5000 may include a guide frame 3100 for guiding the movement of the lens module 2000, a second magnet 5100a and a second coil 5100b for generating a driving force in a first axis (X-axis) direction perpendicular to the optical axis (Z-axis), and a third magnet 5300a and a third coil 5300b for generating a driving force in a second axis (Y-axis) direction perpendicular to the optical axis (Z-axis).

The guide frame 3100 and the lens holder 2300 may be sequentially disposed in the carrier 3000 in the optical axis (Z-axis) direction, and may serve to guide the movement of the lens barrel 2100.

The guide frame 3100 and the lens holder 2300 each may have an opening in the optical axis (Z-axis) direction into which the lens barrel 2100 may be inserted. The lens barrel 2100 may be moved together with the lens holder 2300 in the direction perpendicular to the optical axis (Z-axis).

The guide frame 3100 may be a rectangular plate having an opening in the optical axis (Z-axis).

The guide frame 3100 and the lens holder 2300 may be moved relative to the carrier 3000 by the driving forces generated by the second and third magnets 5100a and 5300a and the second and third coils 5100b and 5300b in the direction perpendicular to the optical axis (Z-axis).

The second magnet 5100a and the second coil 5100b may generate the driving force in the first axis (X-axis) direction perpendicular to the optical axis (Z-axis), and the third magnet 5300a and the third coil 5300b may generate the driving force in the second axis (Y-axis) direction perpendicular to the first axis (X-axis) direction. That is, the second magnet 5100a and the second coil 5100b may generate the driving force in a direction (the first axis (X-axis) direction) in which the second magnet 5100a and the second coil 5100b face each other, and the third magnet 5300a and the third coil 5300b may generate the driving force in a direction (the first axis (X-axis) direction) in which the third magnet 5300a and the third coil 5300b face each other.

A second axis (Y-axis) refers to an axis that is perpendicular to both the optical axis (Z-axis) and the first axis (X-axis).

The second and third magnets 5100a and 5300a may be disposed perpendicular to each other in a plane perpendicular to the optical axis (Z-axis), and the second and third coils 5100b and 5300b may also be disposed perpendicular to each other in the plane perpendicular to the optical axis (Z-axis).

The second and third magnets 5100a and 5300a may be mounted on the lens holder 2300. For example, the second and third magnets 5100a and 5300a may be mounted on the side surface of the lens holder 2300.

The side surface of the lens holder 2300 may include a first surface and a second surface perpendicular to each other, the second magnet 5100a may be disposed on the first surface of the lens holder 2300, and the third magnet 5300a may be disposed on the second surface of the lens holder 2300.

The second and third coils 5100b and 5300b may be mounted on the substrate 4700. For example, the second and third coils 5100b and 5300b may be mounted on one surface of the substrate 4700 to face the second and third magnets 5100a and 5300a.

The substrate 4700 may be mounted on the side surface of the housing 1100, and the second and third coils 5100b and 5300b may directly face the second and third magnets 5100a and 5300a through openings formed in the housing 1100.

During the optical image stabilization, the second and third magnets 5100a and 5300a may be moving members that are moved together with the lens holder 2300 in the direction perpendicular to the optical axis (Z-axis), and the second and third coils 5100b and 5300b are fixed members that are fixed to the housing 1100.

The camera module 5 may include a plurality of ball units for supporting the guide frame 3100 and the lens holder 2300. The plurality of ball units may function to guide the movements of the guide frame 3100, the lens holder 2300, and the lens barrel 2100 in an optical image stabilization process. In addition, the plurality of ball units may also function to maintain a spacing between the carrier 3000 and the guide frame 3100, and a spacing between the guide frame 3100 the lens holder 2300.

The plurality of ball units may include a third ball unit B3 and a fourth ball unit B4.

The third ball unit B3 may guide the movement of the guide frame 3100, the lens holder 2300, and the lens barrel 2100 in the first axis (X-axis) direction, and the fourth ball unit B4 may guide the movement of the lens holder 2300 and the lens barrel 2100 in the second axis (Y-axis) direction.

For example, the third ball unit B3 may roll in the first axis (X-axis) direction when the driving force is generated in the first axis (X-axis) direction. Therefore, the third ball unit B3 may guide the movement of the guide frame 3100, the lens holder 2300, and the lens barrel 2100 in the first axis (X-axis) direction. The third ball unit B3 may also function to maintain a spacing between the carrier 3000 and the guide frame 3100.

The fourth ball unit B4 may roll in the second axis (Y-axis) direction when the driving force is generated in the second axis (Y-axis) direction. Therefore, the fourth ball unit B4 may guide the movement of the lens holder 2300 and the lens barrel 2100 in the second axis (Y-axis) direction. The fourth ball unit B4 may also function to maintain a spacing between the guide frame 3100 and the lens module 2000.

The third ball unit B3 may include a plurality of balls disposed between the carrier 3000 and the guide frame 3100, and the fourth ball unit B4 may include a plurality of balls disposed between the guide frame 3100 and the lens holder 2300.

For example, the third ball unit B3 and the fourth ball unit B4 may each include at least three balls.

A plurality of fifth guide grooves 3010 for accommodating the third ball unit B3 may be formed in either one or both of a surface of the carrier 3000 and a surface of the guide frame 3100 facing each other in the optical axis (Z-axis) direction. The plurality of fifth guide grooves 3010 may be provided to correspond to the plurality of balls included in the third ball unit B3.

The third ball unit B3 may be accommodated in the plurality of fifth guide grooves 3010 and fitted between the carrier 3000 and the guide frame 3100.

The third ball unit B3 accommodated in the plurality of fifth guide grooves 3010 may be restricted from moving in the optical axis (Z-axis) direction and the second axis (Y-axis) direction, and may be allowed to move only in the first axis (X-axis) direction. For example, the third ball unit B3 may be allowed to roll only in the first axis (X-axis) direction.

To this end, each of the plurality of fifth guide grooves 3010 may have a rectangular shape elongated in the first axis (X-axis) direction.

A plurality of sixth guide grooves 3110 for accommodating the fourth ball unit B4 may be formed in either one or both of a surface of the guide frame 3100 and a surface of the lens holder 2300 facing each other in the optical axis (Z-axis) direction. The plurality of sixth guide grooves 3110 may be provided to correspond to the plurality of balls included in the fourth ball unit B4.

The fourth ball unit B4 may be accommodated in the plurality of sixth guide grooves 3110 and fitted between the guide frame 3100 and the lens holder 2300.

The fourth ball unit B4 accommodated in the plurality of sixth guide grooves 3110 may be restricted from moving in the optical axis (Z-axis) direction and the first axis (X-axis) direction, and may be allowed to move only in the second axis (Y-axis) direction. For example, the fourth ball unit B4 may be allowed to roll only in the second axis (Y-axis) direction.

To this end, each of the plurality of sixth guide grooves 3110 may have a rectangular shape elongated in the second axis (Y-axis) direction.

The guide frame 3100, the lens holder 2300, and the lens barrel 2100 may be moved together in the first axis (X-axis) direction when the driving force is generated in the first axis (X-axis) direction.

In this case, the third ball unit B3 may roll along the first axis X-axis, and the movement of the fourth ball unit B4 may be restricted in the first axis (X-axis direction.

In addition, the lens holder 2300 and the lens barrel 2100 may be moved in the second axis (Y-axis) direction when the driving force is generated in the second axis (Y-axis) direction.

In this case, the fourth ball unit B4 may roll along the second axis (Y-axis), and the movement of the third ball unit B3 may be restricted in the second axis (Y-axis) direction.

The present disclosure uses a closed-loop control method for detecting and feeding back a position of the lens module 2300 in the optical image stabilization process.

Accordingly, the present disclosure uses a second position sensor 5500 and a third position sensor 5700 for the closed-loop control. The second and third position sensors 5500 and 5700 may respectively be disposed in through-holes formed in the centers of the second and third coils 5100b and 5300b to face the second and third magnets 5100a and 5300a. The second and third position sensors 5500 and 5700 may be Hall sensors.

The camera module 5 includes a first yoke 7100 and a second yoke 7300 so that the guide frame 3100 and the lens holder 2300 may be kept in contact with the third and fourth ball units B3 and B4.

The first and second yokes 7100 and 7300 may be mounted on the carrier 3000, and disposed to face the second and third magnets 5100a and 5300a in the optical axis (Z-axis) direction.

Accordingly, attractive forces may be generated between the first and second yokes 7100 and 7300 and the second and third magnets 5100a and 5300a in the optical axis (Z-axis) direction.

The lens holder 2300 and the guide frame 3100 may be pressed toward the first and second yokes 7100 and 7300 by the attractive forces acting between the first and second yokes 7100 and 7300 and the second and third magnets 5100a and 5300a, and the guide frame 3100 and the lens holder 2300 may thus be kept in contact with the third and fourth ball units B3 and B4.

The first and second yokes 7100 and 7300 may each be made of a material that may generate the attractive forces between the second and third magnets 5100a and 5300a. For example, the first and second yokes 7100 and 7300 may each be made of a magnetic material.

A stopper 3200 may be coupled to the carrier 3000 to cover at least a portion of an upper surface of the lens holder 2300.

The stopper 3200 may prevent the frame 3100 and the lens holder 2300 from being separated externally from the carrier 3000 due to an external impact or other disturbance.

A plurality of first buffer members 2310 may be disposed on the upper surface of the lens holder 2300 (e.g., the surface of the lens holder 2300 facing the stopper 3200 in the optical axis (Z-axis) direction). Accordingly, plurality of first buffer members 2310 may reduce an impact and a noise occurring when the lens holder 2300 collides with the stopper 3200 when the lens holder 2300 is moved in the optical axis (Z-axis) direction.

In addition, a plurality of second buffer members 2330 may be disposed on a side surface of the lens holder 2300 (e.g., a surface of the lens holder 2300 facing an inner side surface of the carrier 3000 in the direction perpendicular to the optical axis (Z-axis)) direction. Accordingly, the second buffer member 2330 may reduce an impact and a noise occurring when the lens holder 2300 collides with the carrier 3000 when the lens holder 2300 is moved in the direction perpendicular to the optical axis (Z-axis) direction.

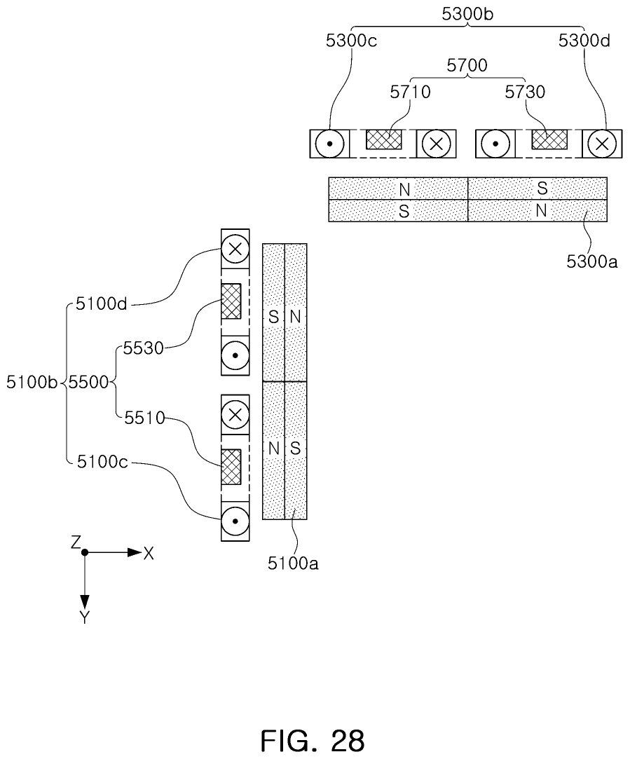

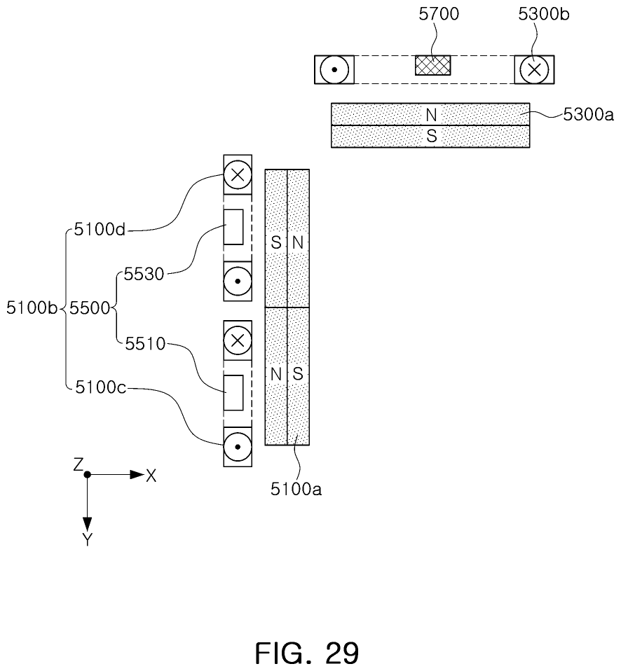

FIG. 28 is a view illustrating an arrangement of second and third magnets, second and third coils, and second and third position sensors of the camera module of FIG. 25, and FIG. 29 is a modified example of FIG. 28.

First, referring to FIG. 28, one surface of the second magnet 5100a may be magnetized to have an N pole and an S pole in a length direction of the second magnet 5100a. In addition, the other surface (i.e., a surface opposite to the one surface) of the second magnet 5100a may be magnetized to have an S pole and an N pole in the length direction of the second magnet 5100a so that the S pole on the other surface opposes the N pole on the one surface, and the N pole on the other surface opposes the S pole on the one surface.

A second coil 5100b may be disposed to face the one surface of the second magnet 5100a. The second coil 5100b may include a first sub-coil 5100c facing the N pole on the one surface of the second magnet 5100a and a second sub-coil 5100d facing the S pole on the one surface of the second magnet 5100a. Thus, the second coil 5100b may include two sub-coils.

In addition, the second position sensor 5500 may include a 2-1-th position sensor 5510 disposed in a center opening of the first sub-coil 5100c, and a 2-2-th position sensor 5530 disposed in a center opening of the second sub-coil 5100d.

The 2-1-th position sensor 5510 may be disposed to face the N pole on the one surface of the second magnet 5100a facing the first sub-coil 5510, and the 2-2-th position sensor 5530 may be disposed to face the S pole on the one surface of the second magnet 5100a facing the second sub-coil 5530.

This configuration may make it possible to offset a rotational force that may occur when the lens module 2000 is moved in the direction perpendicular to the optical axis (Z-axis).

For example, there is a risk that there may be a difference between the driving force generated in the first axis (X-axis) direction and the driving force generated in the second axis (Y-axis) direction that may cause the lens module 2000 to rotate to rotate about the optical axis (Z-axis) or an axis parallel to the optical axis (Z-axis), or that a rotational force may act on the lens module 2100 due to another unintended factor.

The lens module 2000 may be prevented from being rotated by the fifth and sixth guide grooves 3010 and 3110 in which the third and fourth ball units B3 and B4 are disposed. However, the lens module 2000 may still be rotated by a small amount due to an effect of a manufacturing tolerance permitted in a process of manufacturing the camera module 5.

Accordingly, the camera module 5 may detect whether the lens module 2000 is rotated by including the plurality of position sensors 5510 and 5530 facing opposite polarities of the second magnet 5100a. In addition, the camera module 5 may generate a driving force that may offset a rotational force acting on the lens module 2000 by including the plurality of sub-coils 5100c and 5100d facing opposite polarities of the second magnet 5100a.

Referring to FIG. 28, this example embodiment includes one second magnet 5100a. However, the second magnet 5100a is not limited to one magnet, and it may include two magnets separated from each other in the second (Y-axis) direction, with one of the two magnets facing the first sub-coil 5100c, and the other one of the two magnets facing the second sub-coil 5100d. In this case, the magnet facing the sub-coil 5100c may have one surface having an N pole facing the sub-coil 5100c, and another surface having an S pole facing away from the sub-coil 5100c. Also, the magnet facing the sub-coil 5100d may have one surface having an S pole facing the sub-coil 5100D, and another surface having an N pole facing away from the sub-coil 5100d. Alternatively, the magnet facing the sub-coil 5100c may have one surface having an S pole facing the sub-coil 5100c, and another surface having an N pole facing away from the sub-coil 5100c. Also, the magnet facing the sub-coil 5100d may have one surface having an N pole facing the sub-coil 5100D, and another surface having an S pole facing away from the sub-coil 5100d.

In addition, referring to FIG. 28, configurations of the third magnet 5300a, the third coil 5300b, and the third position sensor 5700 may be the same as those of the second magnet 5100a, the second coil 5100b and the second position sensor 5500.

For example, the third coil 5300b may include a third sub-coil 5300c and a fourth sub-coil 5300d. In addition, the third position sensor 5510 may include a 3-1-th position sensor 5710 and a 3-2-th position sensor 5730.

However, the third coil 5300b is not limited to two sub-coils, and may include only one coil as shown in FIG. 29. In this case, the third magnet 5300a may have one surface having an N pole facing the third coil 5300b, and another surface having an S pole facing away from the third coil 5300b as shown in FIG. 29. Alternatively, the third magnet 5300a may have one surface having an S pole facing the third coil 5300b, and another surface having an N pole facing away from the third coil 5300b. Also, the third position sensor 5700 may include only one position sensor as shown in FIG. 29.

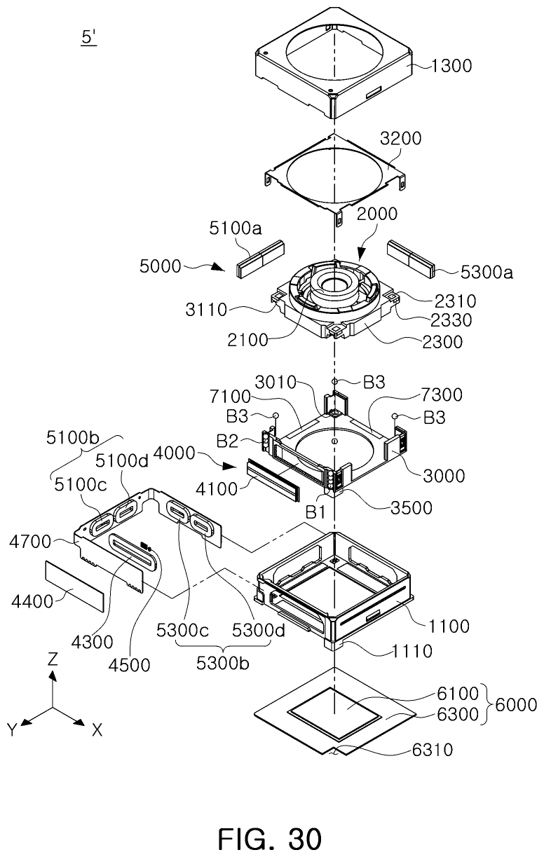

FIG. 30 is an exploded perspective view of a modified example of the camera module of FIG. 25.

Referring to FIG. 30, a camera module 5′ includes a different configuration for guiding the movement of the lens module 2000 when compared with the camera module 5 shown in FIG. 25.

Referring to FIG. 30, the camera module 5′ does not include the guide frame 3100 disposed between the carrier 3000 and the lens module 2000 that is included in the camera module 5 shown in FIG. 25. In addition, the camera module 5′ not including the guide frame 3100 does not include the fourth unit B4 disposed between the guide frame 3100 and the lens module 2000 that is included in the camera module 5 shown in FIG. 25.

The lens module 2000 may be moved in the housing 1100 in the first axis (X-axis) direction and the second axis (Y-axis) direction.

The third ball unit B3 may be disposed between the carrier 3000 and the lens module 2000. The third ball unit B3 may be disposed to be in contact with each of the carrier 3000 and the lens module 2000.

The third ball unit B3 may serve to guide the lens module 2000 to be moved in two axis directions during the optical image stabilization process. In addition, the third ball unit B3 may also serve to maintain a spacing between the carrier 3000 and the lens module 2000.

The third ball unit B3 may guide the movements of the lens module 2000 in both the first axis (X-axis) direction and the second axis (Y-axis) direction.

For example, the third ball unit B3 may roll in the first axis (X-axis) direction when the driving force is generated in the first axis (X-axis) direction. Therefore, the third ball unit B3 may guide the movement of the lens module 2000 in the first axis (X-axis) direction.

In addition, the third ball unit B3 may roll in the second axis (Y-axis) direction when the driving force is generated in the second axis (Y-axis) direction. Therefore, the third ball unit B3 may guide the movement of the lens module 2000 in the second axis (Y-axis) direction.

As set forth above, the camera module according to the example embodiments of the present disclosure may have a smaller size and an improved autofocusing performance.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens module comprising at least one lens;
a housing in which the lens module is disposed;
a magnet disposed on the lens module;
a coil facing the magnet;
a first yoke member fixed to the housing; and
a first ball unit and a second ball unit disposed between the lens module and the housing, spaced apart from each other in a first direction perpendicular to an optical axis of the lens module, and each comprising a plurality of balls disposed in a direction parallel to the optical axis,
wherein the lens module comprises a first extension protruding in the direction parallel to the optical axis,
the housing comprises a second extension protruding in the direction parallel to the optical axis and accommodating at least a portion of the first extension, and
at least one ball among the plurality of balls included in the first ball unit or the plurality of balls included in the second ball unit is disposed between the first extension and the second extension.

2. The camera module of claim 1, wherein a number of the plurality of balls included in the first ball unit is different from a number of the plurality of balls included in the second ball unit.

3. The camera module of claim 2, wherein a distance between two balls respectively positioned at outermost sides in the direction parallel to the optical axis among the plurality of balls included in the first ball unit is greater than a distance between two balls respectively positioned at outermost sides in the direction parallel to the optical axis among the plurality of balls included in the second ball unit.

4. The camera module of claim 3, wherein the at least one ball disposed between the first extension and the second extension is at least one ball among the plurality of balls included in the first ball unit.

5. The camera module of claim 4, wherein a center of gravity of the lens module is positioned closer to the first ball unit than to the second ball unit.

6. The camera module of claim 3, wherein at least a portion of at least one ball among the plurality of balls included in the first ball unit is positioned below the magnet in the direction parallel to the optical axis.

7. The camera module of claim 2, wherein two balls respectively positioned at outermost sides in the direction parallel to the optical axis among the plurality of balls included in the first ball unit are in two-point contact with the lens module and the housing, and
two balls respectively positioned at outermost sides in the direction parallel to the optical axis among the plurality of balls included in the second ball unit are in two-point contact with the lens module and one-point contact with the housing, or are in one-point contact with the lens module and two-point contact with the housing.

8. The camera module of claim 2, wherein an action center point of an attractive force acting between the magnet and the first yoke member is positioned closer to the first ball unit than to the second ball unit.

9. The camera module of claim 8, wherein a center of the magnet is positioned closer to the first ball unit than to the second ball unit.

10. The camera module of claim 1, further comprising a second yoke member fixed to the housing and facing the magnet,
wherein the second yoke member is positioned closer to a ball unit including more balls among the first ball unit and the second ball unit.

11. The camera module of claim 10, further comprising a substrate fixed to the housing,
wherein the coil and the second yoke member are disposed on one surface of the substrate, and the first yoke member is disposed on another surface of the substrate.

12. The camera module of claim 10, further comprising a substrate fixed to the housing and comprising a through-hole passing through the substrate,
wherein the coil is disposed on one surface of the substrate, and the first yoke member is disposed on another surface of the substrate, and
the second yoke member is mounted on the first yoke member facing the magnet through the through-hole hole.

13. The camera module of claim 1, further comprising a buffer member disposed on either one or both of a surface of the first extension and a surface of the second extension facing each other in the direction parallel to the optical axis.

14. The camera module of claim 1, wherein the magnet is disposed closer to a lower surface of the lens module than to an upper surface of the lens module.

15. The camera module of claim 1, further comprising:
a printed circuit board coupled to the housing; and
an image sensor mounted on the printed circuit board and comprising an imaging surface,
wherein the printed circuit board comprises a clearance region in which the second extension is disposed, and
the clearance region is a recess formed in a surface of the printed circuit board facing the housing in the direction parallel to the optical axis, or a through-hole passing through the substrate in the direction parallel to the optical axis.

16. A camera module comprising:
a lens module comprising at least one lens;
a housing in which the lens module is disposed;
a magnet disposed on the lens module;
a coil facing the magnet;
a first yoke member fixed to the housing;
a first ball unit and a second ball unit disposed between the lens module and the housing, spaced apart from each other in a first direction perpendicular to an optical axis of the lens module, and each comprising a plurality of balls disposed in a direction parallel to the optical axis;
a printed circuit board coupled to the housing; and
an image sensor mounted on the printed circuit board and comprising an imaging surface,
wherein a number of the plurality of balls included in the first ball unit is greater than a number of the plurality of balls included in the second ball unit, and
at least a portion of one ball among two balls respectively positioned at outermost sides in the direction parallel to the optical axis among the plurality of balls included in the first ball unit is positioned below the imaging surface.

17. The camera module of claim 16, wherein each ball among the two balls respectively positioned at the outermost sides in the direction parallel to the optical axis among the plurality of balls included in the first ball unit has a diameter greater than a diameter of at least one ball among the plurality of balls included in the first ball unit positioned between the two balls.

18. The camera module of claim 16, wherein the lens module comprises a first extension protruding in the direction parallel to the optical axis,
the housing comprises a second extension protruding in the direction parallel to the optical axis and accommodating at least a portion of the first extension;
at least one ball among the plurality of balls included in the first ball unit is disposed between the first extension and the second extension, and
at least a portion of the at least one ball disposed between the first extension and the second extension is positioned below the imaging surface.

19. The camera module of claim 18, wherein the printed circuit board comprises a clearance region in which the second extension is disposed, and
the clearance region is a recess formed in a surface of the printed circuit board facing the housing in the direction parallel to the optical axis, or a through-hole passing through the printed-circuit board in the direction parallel to the optical axis.

20. The camera module of claim 16, wherein an action center point of an attractive force acting between the magnet and the first yoke member is positioned closer to the first ball unit than to the second ball unit.

21. The camera module of claim 16, wherein a center of gravity of the lens module is positioned closer to the first ball unit than to the second ball unit.

22. A camera module comprising:
a lens module comprising at least one lens and a first extension protruding in a direction parallel to an optical axis of the lens module;
a housing comprising a second extension protruding in the direction parallel to the optical axis and accommodating at least a portion of the first extension;
a first ball unit and a second ball unit disposed between the lens module and the housing, spaced apart from each other in a first direction perpendicular to the optical axis, and each comprising a plurality of balls disposed in the direction parallel to the optical axis;
a fixed frame coupled to the housing and comprising a first accommodation part in which the second extension is disposed;
a moving frame disposed in the fixed frame and configured to be movable on a plane perpendicular to the optical axis;
a third ball unit disposed between the fixed frame and the moving frame;
a sensor substrate comprising:
a moving part coupled to the moving frame; and
a fixed part coupled to the fixed frame; and
an image sensor mounted on the moving part,
wherein at least one ball among the plurality of balls included in the first ball unit or the plurality of balls included in the second ball unit is disposed between the first extension and the second extension.

23. The camera module of claim 22, further comprising a first driving unit configured to move the lens module in an optical axis direction of the lens module,
wherein the first driving unit comprises:
a first magnet disposed on the lens module;
a first coil fixed to the housing and facing the first magnet; and
a first yoke member fixed to the housing,
a number of the plurality of balls included in the first ball unit is greater than a number of the plurality of balls included in the second ball unit, and
each ball among two balls respectively positioned at outermost sides in the direction parallel to the optical axis among the plurality of balls included in the first ball unit has a diameter greater than a diameter of at least one ball among the plurality of balls included in the first ball unit positioned between the two balls.

24. The camera module of claim 23, wherein an action center point of an attractive force acting between the first magnet and the first yoke member is positioned closer to the first ball unit than to the second ball unit.

25. The camera module of claim 22, further comprising:
a second driving unit configured to drive the lens module in the first direction perpendicular to the optical axis; and
a third driving unit configured to drive the lens module in a second direction perpendicular to both the optical axis and the first direction,
wherein the second driving unit comprises a second magnet disposed on the moving frame and a second coil fixed to the fixed frame, or a second magnet disposed on the fixed frame and a second coil fixed to the moving frame,
the third driving unit comprises a third magnet disposed on the moving frame and a third coil fixed to the fixed frame, or a third magnet disposed on the fixed frame and a third coil fixed to the moving frame,
the second magnet and the second coil face each other in the direction parallel to the optical axis, and
the third magnet and the third coil face each other in the direction parallel to the optical axis.

26. The camera module of claim 22, wherein the sensor substrate further comprises a connection part connecting the moving part and the fixed part with each other, and
the connection part comprises a plurality of slits extending along a perimeter of the moving part and passing through the connection part in the optical axis direction.

27. A camera module comprising:
a lens module comprising at least one lens;
a carrier in which the lens module is disposed;
a housing in which the carrier having the lens module disposed therein is disposed;
a first substrate mounted on the housing;
an autofocusing unit comprising a first magnet disposed on the carrier and a first coil disposed on the first substrate;
an optical image stabilization unit comprising a second magnet and a third magnet disposed on the lens module, and a second coil and a third coil disposed on the first substrate;
a first ball unit and a second ball unit disposed between the carrier and the housing, spaced apart from each other in a first direction perpendicular to an optical axis of the lens module, and each comprising a plurality of balls disposed in a direction parallel to the optical axis; and
a ball unit supporting the lens module so that the lens module is movable relative to the carrier in the direction perpendicular to the optical axis,
wherein a number of the plurality of balls included in the first ball unit is greater than a number of the plurality of balls included in the second ball unit,
the carrier comprises a first extension protruding in the direction parallel to the optical axis,
the housing comprises a second extension protruding in the direction parallel to the optical axis and accommodating at least a portion of the first extension; and
at least one ball among the plurality of balls included in the first ball unit is disposed between the first extension and the second extension.

28. The camera module of claim 27, wherein each ball among two balls respectively positioned at outermost sides in the direction parallel to the optical axis among the plurality of balls included in the first ball unit has a diameter greater than a diameter of at least one ball among the plurality of balls included in the first ball unit positioned between the two balls, and
at least one ball among the two balls respectively positioned at outermost sides in the direction parallel to the optical axis is disposed between the first extension and the second extension.

29. The camera module of claim 27, further comprising a first yoke member mounted on the first substrate,
wherein an action center point of an attractive force acting between the first magnet and the first yoke member is positioned closer to the first ball unit than to the second ball unit.

30. The camera module of claim 27, wherein the lens module and the carrier are configured to be movable together in an optical axis direction of the lens module, and
the lens module is configured to be movable relative to the carrier in the first direction perpendicular to the optical axis and a second direction perpendicular to the optical axis and intersecting the first direction.

31. The camera module of claim 27, further comprising:
a printed circuit board coupled to the housing; and
an image sensor mounted on the printed circuit board and comprising an imaging surface,
wherein the printed circuit board comprises a clearance region in which the second extension is disposed, and
the clearance region is a recess formed in a surface of the printed circuit board facing the substrate in the direction parallel to the optical axis, or a through-hole passing through the substrate in the direction parallel to the optical axis.
